(19) United States
(12) Patent Application Publication
(10) Pub. No.: US 2022/0155561 A1
(43) Pub. Date: May 19, 2022

(54) Optical Imaging Lens Assembly

(71) Applicant: ZHEJIANG SUNNY OPTICS CO.,LTD., Ningbo (CN)

(72) Inventors: Shuang ZHANG, Ningbo (CN); Xiaobin ZHANG, Ningbo (CN); Jianke WENREN, Ningbo (CN); Fujian DAI, Ningbo (CN); Liefeng ZHAO, Ningbo (CN)

(21) Appl. No.: 17/524,757

(22) Filed: Nov. 12, 2021

(30) Foreign Application Priority Data
Nov. 19, 2020 (CN) 202011305071.4

(51) Int. Cl. G02B 9/64; G02B 13/00; G02B 3/04; G02B 27/00

(52) U.S. Cl. CPC G02B 9/64; G02B 13/0045; G02B 2003/0093; G02B 27/0025; G02B 3/04

(57) ABSTRACT

The disclosure provides an optical imaging lens assembly, which sequentially includes from an object side to an image side along an optical axis: a first lens with a positive refractive power, an object-side surface thereof is a convex surface, and an image-side surface thereof is a flat surface; a variable diaphragm; a second lens with a negative refractive power; a third lens with a refractive power; a fourth lens with a positive refractive power, an image-side surface thereof is a convex surface; a fifth lens with a refractive power; a sixth lens with a positive refractive power; and a seventh lens with a negative refractive power. The first lens is a glass lens. The image-side surface of the first lens is a spherical mirror surface.

### CROSS-REFERENCE TO RELATED PRESENT INVENTION(S)

The disclosure claims priority to and the benefit of Chinese Patent Present invention No. 202011305071.4, filed in the China National Intellectual Property Administration (CNIPA) on 19 Nov. 2020, which is incorporated herein by reference in its entirety.

### TECHNICAL FIELD

The disclosure relates to the technical field of optical elements, and more particularly to an optical imaging lens assembly.

### BACKGROUND

In recent years, with the rapid development of portable electronic products such as smart phones, camera functions of portable electronic products such as smart phones have become increasingly powerful, and shooting effects have gotten better and better. There is an increasing tendency of using portable electronic products such as smart phones as main photographic tools in photography and other industries because of small size, light weight and portability of portable electronic products such as smart phones.

At present, photographing with mobile phones not only records details in people's lives but even also goes deep into promotion copies of some brands. Meanwhile, with the development of the industry of photographing with mobile phones, higher requirements have been made to lenses of mobile phones on the market. A lens of a conventional mobile phone cannot simultaneously achieve a relatively great depth of field of a long shot and make a close shot layered. Therefore, how to satisfy requirements of different shooting scenes on the basis of implementing the miniaturization of a camera lens is one of various problems urgent to be solved by lens designers at present.

### SUMMARY

An embodiment of the disclosure provides an optical imaging lens assembly, which sequentially includes from an object side to an image side along an optical axis: a first lens with a positive refractive power, an object-side surface thereof is a convex surface, and an image-side surface thereof is a flat surface; a variable diaphragm; a second lens with a negative refractive power; a third lens with a refractive power; a fourth lens with a positive refractive power, an image-side surface thereof is a convex surface; a fifth lens with a refractive power; a sixth lens with a positive refractive power; and a seventh lens with a negative refractive power. The first lens is a glass lens. The image-side surface of the first lens is a spherical mirror surface.

In an implementation mode, an object-side surface of the second lens to an image-side surface of the seventh lens includes at least one aspheric mirror surface.

In an implementation mode, EPDₘₐₓ is a maximum entrance pupil diameter of the optical imaging lens assembly, EPDₘᵢₙ is a minimum entrance pupil diameter of the optical imaging lens assembly, and EPDₘₐₓ, EPDₘᵢₙ and an effective focal length f1 of the first lens may satisfy 4.0<f1/(EPDₘₐₓ−EPDₘᵢₙ)<5.0.

In an implementation mode, an effective focal length f2 of the second lens, an effective focal length f3 of the third lens and an effective focal length f7 of the seventh lens may satisfy 1.0<f3/(f2+f7)<2.0.

In an implementation mode, an effective focal length f4 of the fourth lens and a curvature radius R7 of an object-side surface of the fourth lens may satisfy 1.2<f4/R7<1.7.

In an implementation mode, a curvature radius R12 of an image-side surface of the sixth lens, a curvature radius R11 of an object-side surface of the sixth lens and an effective focal length f6 of the sixth lens may satisfy 1.2<(R11+R12)/f6<1.7.

In an implementation mode, a curvature radius R3 of an object-side surface of the second lens and a curvature radius R4 of an image-side surface of the second lens may satisfy 1.8<R3/R4<2.3.

In an implementation mode, a curvature radius R5 of an object-side surface of the third lens and a curvature radius R6 of an image-side surface of the third lens may satisfy 1.4<R5/R6<2.0.

In an implementation mode, a center thickness CT1 of the first lens on the optical axis, a center thickness CT2 of the second lens on the optical axis, a center thickness CT3 of the third lens on the optical axis, a spacing distance T12 of the first lens and the second lens on the optical axis and a spacing distance T23 of the second lens and the third lens on the optical axis may satisfy 0.8<(CT1+T12)/(CT2+T23+CT3)<1.2.

In an implementation mode, an effective radius DT31 of an object-side surface of the third lens, an effective radius DT32 of an image-side surface of the third lens and an effective radius DT11 of the object-side surface of the first lens may satisfy 1.6<(DT31+DT32)/DT11<2.0.

In an implementation mode, a combined focal length f12 of the first lens and the second lens and a combined focal length f34 of the third lens and the fourth lens may satisfy 2.9<f34/f12<4.9.

In an implementation mode, a combined focal length f56 of the fifth lens and the sixth lens, a center thickness CT5 of the fifth lens on the optical axis and a center thickness CT6 of the sixth lens on the optical axis may satisfy 6.5<f56/(CT5+CT6)<7.5.

In an implementation mode, SAG52 is a distance from an intersection point of an image-side surface of the fifth lens and the optical axis to an effective radius vertex of the image-side surface of the fifth lens on the optical axis, SAG51 is a distance from an intersection point of an object-side surface of the fifth lens and the optical axis to an effective radius vertex of the object-side surface of the fifth lens on the optical axis, SAG72 is a distance from an intersection point of an image-side surface of the seventh lens and the optical axis to an effective radius vertex of the image-side surface of the seventh lens on the optical axis, SAG71 is a distance from an intersection point of an object-side surface of the seventh lens and the optical axis to an effective radius vertex of the object-side surface of the seventh lens on the optical axis, and SAG52, SAG51, SAG72 and SAG71 may satisfy 1.1<(SAG71+SAG72)/(SAG51+SAG52)<1.8.

In an implementation mode, an object-side surface of the fifth lens is a convex surface, and an image-side surface of the fifth lens is a concave surface.

In an implementation mode, an object-side surface of the sixth lens is a convex surface, and an image-side surface of the sixth lens is a concave surface.

Another embodiment of the disclosure provides an optical imaging lens assembly, which sequentially includes from an object side to an image side along an optical axis: a first lens with a positive refractive power, an object-side surface thereof is a convex surface, and an image-side surface thereof is a flat surface; a variable diaphragm; a second lens with a negative refractive power; a third lens with a refractive power; a fourth lens with a positive refractive power, an image-side surface thereof is a convex surface; a fifth lens with a refractive power; a sixth lens with a positive refractive power; and a seventh lens with a negative refractive power. EPDₘₐₓ is a maximum entrance pupil diameter of the optical imaging lens assembly, EPDₘᵢₙ is a minimum entrance pupil diameter of the optical imaging lens assembly, and EPDₘₐₓ, EPDₘᵢₙ and an effective focal length f1 of the first lens may satisfy 4.0<f1/(EPDₘₐₓ−EPDₘᵢₙ)<5.0.

In an implementation mode, an effective focal length f2 of the second lens, an effective focal length f3 of the third lens and an effective focal length f7 of the seventh lens may satisfy 1.0<f3/(f2+f7)<2.0.

In an implementation mode, an effective focal length f4 of the fourth lens and a curvature radius R7 of an object-side surface of the fourth lens may satisfy 1.2<f4/R7<1.7.

In an implementation mode, a curvature radius R12 of an image-side surface of the sixth lens, a curvature radius R11 of an object-side surface of the sixth lens and an effective focal length f6 of the sixth lens may satisfy 1.2<(R11+R12)/f6<1.7.

In an implementation mode, a curvature radius R3 of an object-side surface of the second lens and a curvature radius R4 of an image-side surface of the second lens may satisfy 1.8<R3/R4<2.3.

In an implementation mode, a curvature radius R5 of an object-side surface of the third lens and a curvature radius R6 of an image-side surface of the third lens may satisfy 1.4<R5/R6<2.0.

In an implementation mode, a center thickness CT1 of the first lens on the optical axis, a center thickness CT2 of the second lens on the optical axis, a center thickness CT3 of the third lens on the optical axis, a spacing distance T12 of the first lens and the second lens on the optical axis and a spacing distance T23 of the second lens and the third lens on the optical axis may satisfy 0.8<(CT1+T12)/(CT2+T23+CT3)<1.2.

In an implementation mode, an effective radius DT31 of an object-side surface of the third lens, an effective radius DT32 of an image-side surface of the third lens and an effective radius DT11 of the object-side surface of the first lens may satisfy 1.6<(DT31+DT32)/DT11<2.0.

In the exemplary implementation mode, a combined focal length f12 of the first lens and the second lens and a combined focal length f34 of the third lens and the fourth lens may satisfy 2.9<f34/f12<4.9.

In an implementation mode, a combined focal length f56 of the fifth lens and the sixth lens, a center thickness CT5 of the fifth lens on the optical axis and a center thickness CT6 of the sixth lens on the optical axis may satisfy 6.5<f56/(CT5+CT6)<7.5.

In an implementation mode, SAG52 is a distance from an intersection point of an image-side surface of the fifth lens and the optical axis to an effective radius vertex of the image-side surface of the fifth lens on the optical axis, SAG51 is a distance from an intersection point of an object-side surface of the fifth lens and the optical axis to an effective radius vertex of the object-side surface of the fifth lens on the optical axis, SAG72 is a distance from an intersection point of an image-side surface of the seventh lens and the optical axis to an effective radius vertex of the image-side surface of the seventh lens on the optical axis, SAG71 is a distance from an intersection point of an object-side surface of the seventh lens and the optical axis to an effective radius vertex of the object-side surface of the seventh lens on the optical axis, and SAG52, SAG51, SAG72 and SAG71 may satisfy 1.1<(SAG71+SAG72)/(SAG51+SAG52)<1.8.

In an implementation mode, the first lens is a glass lens, and the image-side surface of the first lens is a spherical mirror surface.

In an implementation mode, an object-side surface of the fifth lens is a convex surface, and an image-side surface of the fifth lens is a concave surface.

In an implementation mode, an object-side surface of the sixth lens is a convex surface, and an image-side surface of the sixth lens is a concave surface.

According to the disclosure, multiple (for example, seven) lenses are adopted, and the refractive power and surface types of each lens, the center thickness of each lens, on-axis spacing distances between the lenses and the like are reasonably configured to achieve at least one beneficial effect of small size, compact structure, variable aperture, high imaging quality and the like of the optical imaging lens assembly.

### BRIEF DESCRIPTION OF THE DRAWINGS

Detailed descriptions made to unrestrictive embodiments with reference to the following drawings are read to make the other characteristics, purposes and advantages of the disclosure more apparent.

FIG. 1 shows a structural schematic diagram of an optical imaging lens assembly with an F-number of 1.39 according to Embodiment 1 of the disclosure;

FIG. 2 shows a structural schematic diagram of an optical imaging lens assembly with an F-number of 2.04 according to Embodiment 1 of the disclosure;

FIGS. 3A-3C show a longitudinal aberration curve, an astigmatism curve and a distortion curve of an optical imaging lens assembly with an F-number of 1.39 according to Embodiment 1 respectively;

FIGS. 4A-4C show a longitudinal aberration curve, an astigmatism curve and a distortion curve of an optical imaging lens assembly with an F-number of 2.04 according to Embodiment 1 respectively;

FIG. 5 shows a structural schematic diagram of an optical imaging lens assembly with an F-number of 1.39 according to Embodiment 2 of the disclosure;

FIG. 6 shows a structural schematic diagram of an optical imaging lens assembly with an F-number of 2.05 according to Embodiment 2 of the disclosure;

FIGS. 7A-7C show a longitudinal aberration curve, an astigmatism curve and a distortion curve of an optical imaging lens assembly with an F-number of 1.39 according to Embodiment 2 respectively;

FIGS. 8A-8C show a longitudinal aberration curve, an astigmatism curve and a distortion curve of an optical imaging lens assembly with an F-number of 2.05 according to Embodiment 2 respectively;

FIG. 9 shows a structural schematic diagram of an optical imaging lens assembly with an F-number of 1.39 according to Embodiment 3 of the disclosure;

FIG. 10 shows a structural schematic diagram of an optical imaging lens assembly with an F-number of 2.04 according to Embodiment 3 of the disclosure;

FIGS. 11A-11C show a longitudinal aberration curve, an astigmatism curve and a distortion curve of an optical imaging lens assembly with an F-number of 1.39 according to Embodiment 3 respectively;

FIGS. 12A-12C show a longitudinal aberration curve, an astigmatism curve and a distortion curve of an optical imaging lens assembly with an F-number of 2.04 according to Embodiment 3 respectively;

FIG. 13 shows a structural schematic diagram of an optical imaging lens assembly with an F-number of 1.39 according to Embodiment 4 of the disclosure;

FIG. 14 shows a structural schematic diagram of an optical imaging lens assembly with an F-number of 2.04 according to Embodiment 4 of the disclosure;

FIGS. 15A-15C show a longitudinal aberration curve, an astigmatism curve and a distortion curve of an optical imaging lens assembly with an F-number of 1.39 according to Embodiment 4 respectively;

FIGS. 16A-16C show a longitudinal aberration curve, an astigmatism curve and a distortion curve of an optical imaging lens assembly with an F-number of 2.04 according to Embodiment 4 respectively;

FIG. 17 shows a structural schematic diagram of an optical imaging lens assembly with an F-number of 1.40 according to Embodiment 5 of the disclosure;

FIG. 18 shows a structural schematic diagram of an optical imaging lens assembly with an F-number of 2.04 according to Embodiment 5 of the disclosure;

FIGS. 19A-19C show a longitudinal aberration curve, an astigmatism curve and a distortion curve of an optical imaging lens assembly with an F-number of 1.40 according to Embodiment 5 respectively;

FIGS. 20A-20C show a longitudinal aberration curve, an astigmatism curve and a distortion curve of an optical imaging lens assembly with an F-number of 2.04 according to Embodiment 5 respectively;

FIG. 21 shows a structural schematic diagram of an optical imaging lens assembly with an F-number of 1.40 according to Embodiment 6 of the disclosure;

FIG. 22 shows a structural schematic diagram of an optical imaging lens assembly with an F-number of 2.05 according to Embodiment 6 of the disclosure;

FIGS. 23A-23C show a longitudinal aberration curve, an astigmatism curve and a distortion curve of an optical imaging lens assembly with an F-number of 1.40 according to Embodiment 6 respectively; and

FIGS. 24A-24C show a longitudinal aberration curve, an astigmatism curve and a distortion curve of an optical imaging lens assembly with an F-number of 2.05 according to Embodiment 6 respectively.

### DETAILED DESCRIPTION OF THE EMBODIMENTS

For understanding the disclosure better, more detailed descriptions will be made to each aspect of the disclosure with reference to the drawings. It is to be understood that these detailed descriptions are only descriptions about the exemplary implementation modes of the disclosure and not intended to limit the scope of the disclosure in any manner. In the whole specification, the same reference sign numbers represent the same components. Expression “and/or” includes any or all combinations of one or more in associated items that are listed.

It should be noted that, in this description, the expressions of first, second, third, and the like are only used to distinguish one feature from another feature, and do not represent any limitation to the feature. Thus, a first lens discussed below could also be referred to as a second lens or a third lens without departing from the teachings of the disclosure.

In the drawings, the thickness, size and shape of the lens have been slightly exaggerated for ease illustration. In particular, a spherical shape or aspheric shape shown in the drawings is shown by some embodiments. That is, the spherical shape or the aspheric shape is not limited to the spherical shape or aspheric shape shown in the drawings. The drawings are by way of example only and not strictly to scale.

Herein, a paraxial region refers to a region nearby an optical axis. If a lens surface is a convex surface and a position of the convex surface is not defined, it indicates that the lens surface is a convex surface at least in the paraxial region; and if a lens surface is a concave surface and a position of the concave surface is not defined, it indicates that the lens surface is a concave surface at least in the paraxial region. A surface, closest to a shot object, of each lens is called an object-side surface of the lens, and a surface, closest to an imaging surface, of each lens is called an image-side surface of the lens.

It should also be understood that terms “include”, “including”, “have”, “contain”, and/or “containing”, used in the specification, represent existence of a stated characteristic, component and/or part but do not exclude existence or addition of one or more other characteristics, components and parts and/or combinations thereof. In addition, expressions like “at least one in . . . ” may appear after a list of listed characteristics not to modify an individual component in the list but to modify the listed characteristics. Moreover, when the implementation modes of the disclosure are described, “may” is used to represent “one or more implementation modes of the disclosure”. Furthermore, term “exemplary” refers to an example or exemplary description.

Unless otherwise defined, all terms (including technical terms and scientific terms) used in the disclosure have the same meanings as commonly understood by those of ordinary skill in the art of the disclosure. It should also be understood that the terms (for example, terms defined in a common dictionary) should be explained to have the same meanings as those in the context of a related art and may not be explained with ideal or excessively formal meanings, unless clearly defined like this in the disclosure.

It is to be noted that the embodiments in the disclosure and characteristics in the embodiments may be combined without conflicts. The disclosure will be described below with reference to the drawings and in combination with the embodiments in detail.

The features, principles and other aspects of the disclosure will be described below in detail.

An optical imaging lens assembly according to an exemplary embodiment of the disclosure may include seven lenses with refractive power, i.e., a first lens, a second lens, a third lens, a fourth lens, a fifth lens, a sixth lens and a seventh lens respectively. The seven lenses are sequentially arranged from an object side to an image side along an optical axis. In the first lens to the seventh lens, there may be a spacing distance between any two adjacent lenses.

In an exemplary embodiment, the first lens may have a positive refractive power, an object-side surface thereof may be a convex surface, and an image-side surface thereof may be a flat surface; the second lens may have a negative refractive power; the third lens may have a positive refractive power or a negative refractive power; the fourth lens may have a positive refractive power, an image-side surface thereof may be a convex surface; the fifth lens may have a positive refractive power or a negative refractive power; the sixth lens may have a positive refractive power; the seventh lens may have a negative refractive power.

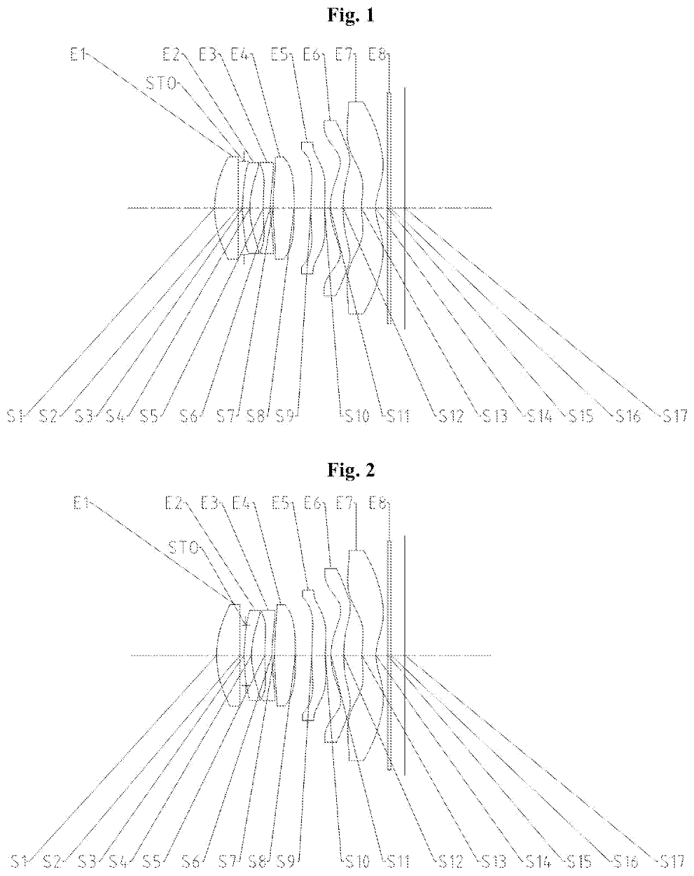

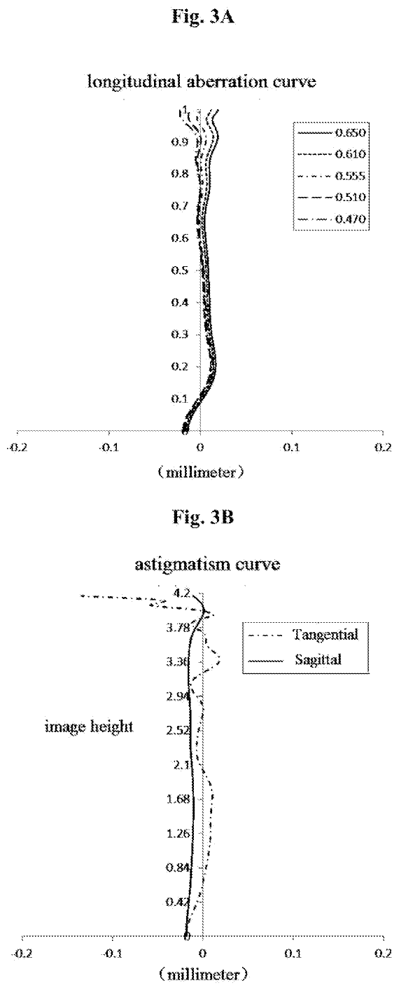

In an exemplary embodiment, the optical imaging lens assembly according to the disclosure further includes a variable diaphragm arranged between the first lens and the second lens. As shown in FIGS. 1-2, the optical imaging lens assembly is provided with a variable diaphragm STO, so that an effect of continuously changing an F-number of the optical imaging lens assembly may be achieved, and the F-number of the lens may change in a relatively large range.

In an exemplary embodiment, the first lens may have the positive refractive power, so that light may be converged well. An object-side surface of the first lens is a convex surface, and the image-side surface of the first lens is a flat surface, so that it is favorably ensured that light may be emitted into the optical imaging lens assembly stably. The image-side surface of the first lens is the flat surface that may fit a diaphragm surface well. The refractive power and surface types of the second lens to the seventh lens are configured reasonably, so that the optical lens assembly is more compact in structure, and light may be transmitted more stably.

In an exemplary embodiment, the first lens may be a glass lens, and at least one of the second lens to the seventh lens may be a plastic lens. The first lens adopts a glass lens, so that the optical imaging lens assembly of the disclosure may be formed by combining glass lenses and plastic lenses, and the optical performance of the lens is further improved.

In an exemplary embodiment, an image-side surface of the first lens may be a spherical mirror surface. Therefore, the variable diaphragm may stably move at the image-side surface of the first lens, and relatively high stability may be ensured when an aperture of the lens is switched.

In the embodiment of the disclosure, at least one of mirror surfaces of each lens is an aspheric mirror surface, namely at least one mirror surface in the object-side surface of the first lens to an image-side surface of the seventh lens is an aspheric mirror surface. An aspheric lens has a characteristic that a curvature keeps changing from a center of the lens to a periphery of the lens. Unlike a spherical lens with a constant curvature from a center of the lens to a periphery of the lens, the aspheric lens has a better curvature radius characteristic and the advantages of improving distortions and improving astigmatic aberrations. With adoption of the aspheric lens, astigmatism aberrations during imaging may be eliminated as much as possible to further improve the imaging quality. In an embodiment, at least one of the object-side surface and the image-side surface of each lens in the first lens, the second lens, the third lens, the fourth lens, the fifth lens, the sixth lens and the seventh lens is an aspheric mirror surface. In another embodiment, the object-side surface of the first lens and the object-side surface and the image-side surface of each lens in the second lens, the third lens, the fourth lens, the fifth lens, the sixth lens and the seventh lens are aspheric mirror surfaces.

In an exemplary embodiment, an object-side surface of the fifth lens may be a convex surface, and an image-side surface of the fifth lens may be a concave surface. By such a surface type set of the fifth lens, gentle light transmission may be ensured, and the phenomenon that the lens is unstable due to an excessively sharp light transmission path may be avoided. In addition, such a surface type set of the fifth lens is also favorable for enlarging an imaging surface of the lens based on a certain total length of the lens.

In an exemplary embodiment, an object-side surface of the sixth lens may be a convex surface, and an image-side surface of the sixth lens may be a concave surface. By such a surface type set of the sixth lens, gentle light transmission may be ensured, and the phenomenon that the lens is unstable due to an excessively sharp light transmission path may be avoided. In addition, such a surface type set of the sixth lens is also favorable for enlarging an imaging surface of the lens based on a certain total length of the lens.

In an exemplary embodiment, the optical imaging lens assembly according to the disclosure may satisfy 4.0≤f1/(EPDₘₐₓ−EPDₘᵢₙ)<5.0, wherein EPDₘₐₓ is a maximum entrance pupil diameter of the optical imaging lens assembly, EPDₘₐₓ is a minimum entrance pupil diameter of the optical imaging lens assembly, and f1 is an effective focal length of the first lens. More specifically, f1, EPDₘₐₓ and EPDₘᵢₙ may further satisfy 4.1<f1/(EPDₘₐₓ−EPDₘᵢₙ)<4.4. 4.0<f1/(EPDₘₐₓ−EPDₘᵢₙ)<5.0 is satisfied, so that the optical imaging lens assembly may have high imaging performance under both a large aperture and a small aperture.

In an exemplary embodiment, the optical imaging lens assembly according to the disclosure may satisfy 1.0≤f3/(f2+f7)<2.0, wherein f2 is an effective focal length of the second lens, f3 is an effective focal length of the third lens, and f7 is an effective focal length of the seventh lens. More specifically, f3, f2 and f7 may further satisfy 1.3<f3/(f2+f7)<1.7. Satisfying 1.0<f3/(f2+f7)<2.0 is favorable for changing spherical aberration contributions of the third lens, the second lens and the seventh lens to comprehensively correct spherical aberrations generated by the three lenses.

In an exemplary embodiment, the optical imaging lens assembly according to the disclosure may satisfy 1.2<f4/R7<1.7, wherein f4 is an effective focal length of the fourth lens, and R7 is a curvature radius of an object-side surface of the fourth lens. More specifically, f4 and R7 may further satisfy 1.3<f4/R7<1.6. 1.2<f4/R7<1.7 is satisfied, so that the shape of the fourth lens may be set reasonably to reduce a spherical aberration generated by the fourth lens, and meanwhile, the shape of the fourth lens may be changed to combine the fourth lens and the third lens to comprehensively correct a chromatic aberration of the lens.

In an exemplary embodiment, the optical imaging lens assembly according to the disclosure may satisfy 1.2<(R11+R12)/f6<1.7, wherein R12 is a curvature radius of an image-side surface of the sixth lens, R11 is a curvature radius of an object-side surface of the sixth lens, and f6 is an effective focal length of the sixth lens. Satisfying 1.2<(R11+R12)/f6<1.7 is favorable for optimizing an edge angle of the sixth lens to further prevent a light transmission anomaly or error by controlling the edge angle of the sixth lens, and is favorable for setting the shape of the sixth lens reasonably to reduce a field curvature of the lens and the phenomenon of internal and external interleaving of field curvature of the lens.

In an exemplary embodiment, the optical imaging lens assembly according to the disclosure may satisfy 1.8<R3/R4<2.3, wherein R3 is a curvature radius of an object-side surface of the second lens, and R4 is a curvature radius of an image-side surface of the second lens. More specifically, R3 and R4 may further satisfy 1.9<R3/R4<2.2. 1.8<R3/R4<2.3 is satisfied, so that the refractive power of the second lens may be set reasonably. Therefore, the refractive power may be indirectly configured to ensure a gentle transition of light transmitted by the first lens to finally achieve an effect of reducing the overall aberration of the lens.

In an exemplary embodiment, the optical imaging lens assembly according to the disclosure may satisfy 1.4<R5/R6<2.0, wherein R5 is a curvature radius of an object-side surface of the third lens, and R6 is a curvature radius of an image-side surface of the third lens. More specifically, R5 and R6 may further satisfy 1.5<R5/R6<1.7. 1.4<R5/R6<2.0 is satisfied, so that the refractive power of the third lens may be set reasonably, the shape of the third lens may be optimized, and the spherical aberration and coma of the lens may be reduced in combination with the second lens.

In an exemplary embodiment, the optical imaging lens assembly according to the disclosure may satisfy 0.8<(CT1+T12)/(CT2+T23+CT3)<1.2, wherein CT1 is a center thickness of the first lens on the optical axis, CT2 is a center thickness of the second lens on the optical axis, CT3 is a center thickness of the third lens on the optical axis, T12 is a spacing distance of the first lens and the second lens on the optical axis, and T23 is a spacing distance of the second lens and the third lens on the optical axis. More specifically, CT1, T12, CT2, T23 and CT3 may further satisfy 0.9<(CT1+T12)/(CT2+T23+CT3)<1.1. 0.8<(CT1+T12)/(CT2+T23+CT3)<1.2 is satisfied, so that lens parameters of the first lens to the third lens may be controlled to reduce the overall field curvature and spherical aberration of the lens, and the reduction of the sensitivity of the lens is further facilitated.

In an exemplary embodiment, the optical imaging lens assembly according to the disclosure may satisfy 1.6<(DT31+DT32)/DT11<2.0, wherein DT31 is an effective radius of an object-side surface of the third lens, DT32 is an effective radius of an image-side surface of the third lens, and DT11 is an effective radius of an object-side surface of the first lens. More specifically, DT31, DT32 and DT11 may further satisfy 1.6<(DT31+DT32)/DT11<1.8. Satisfying 1.6<(DT31+DT32)/DT11<2.0 is favorable for light to continue to be transmitted stably after being converged by the first lens, and is also favorable for reducing a segment gap from the first lens to the third lens, reducing the sensitivity of the lens and improving the yield of the optical imaging lens assembly.

In an exemplary embodiment, the optical imaging lens assembly according to the disclosure may satisfy 2.9<f34/f12<4.9, wherein f12 is a combined focal length of the first lens and the second lens, and f34 is a combined focal length of the third lens and the fourth lens. 2.9≤f34/f12<4.9 is satisfied, so that the refractive power of the first lens to the fourth lens may be configured reasonably to reduce the aberration of the lens and improve the optical performance of the lens.

In an exemplary embodiment, the optical imaging lens assembly according to the disclosure may satisfy 6.5<f56/(CT5+CT6)<7.5, wherein f56 is a combined focal length of the fifth lens and the sixth lens, CT5 is a center thickness of the fifth lens on the optical axis, and CT6 is a center thickness of the sixth lens on the optical axis. More specifically, f56, CT5 and CT6 may further satisfy 6.5<f56/(CT5+CT6)<7.1. Satisfying 6.5<f56/(CT5+CT6)<7.5 is favorable for comprehensively configuring relationships between the refractive power and center thicknesses of the fifth lens and the sixth lens, and is favorable for reducing the spherical aberration and the field curvature.

In an exemplary embodiment, the optical imaging lens assembly according to the disclosure may satisfy 1.1<(SAG71+SAG72)/(SAG51+SAG52)<1.8, wherein SAG52 is a distance from an intersection point of an image-side surface of the fifth lens and the optical axis to an effective radius vertex of the image-side surface of the fifth lens on the optical axis, SAG51 is a distance from an intersection point of an object-side surface of the fifth lens and the optical axis to an effective radius vertex of the object-side surface of the fifth lens on the optical axis, SAG72 is a distance from an intersection point of an image-side surface of the seventh lens and the optical axis to an effective radius vertex of the image-side surface of the seventh lens on the optical axis, and SAG71 is a distance from an intersection point of an object-side surface of the seventh lens and the optical axis to an effective radius vertex of the object-side surface of the seventh lens on the optical axis. Satisfying 1.1<(SAG71+SAG72)/(SAG51+SAG52)<1.8 is favorable for reducing the phenomenon of ghost images generated by the fifth lens and the seventh lens, and is favorable for setting the shapes of the fifth lens and the seventh lens reasonably, reducing the distortion of the lens as well as the astigmatism and field curvature of the lens.

In an exemplary embodiment, the optical imaging lens assembly according to the disclosure may further include an optical filter configured to correct a chromatic aberration and/or a protective glass configured to protect a photosensitive element on the imaging surface.

The optical imaging lens assembly according to the embodiment of the disclosure may adopt multiple lenses, for example, the above-mentioned seven. The refractive power and surface types of each lens, the center thickness of each lens, on-axis spacing distances between the lenses and the like are reasonably configured to effectively reduce the size of the optical imaging lens assembly, improve the machinability of the optical imaging lens assembly and ensure that the optical imaging lens assembly is more favorable for production and machining and applicable to a portable electronic product. The optical imaging lens assembly as configured above has the characteristics of ultra-thin design, large image surface, variable aperture, compact structure, small size, high imaging quality and the like, and may satisfy using requirements of various portable electronic products in a shooting scenario.

However, those skilled in the art should know that the number of the lenses forming the optical imaging lens assembly may be changed without departing from the technical solutions claimed in the disclosure to achieve each result and advantage described in the specification. For example, although descriptions are made in the embodiment with seven lenses as an example, the optical imaging lens assembly is not limited to seven lenses. If necessary, the optical imaging lens assembly may further include another number of lenses.

Specific embodiments applied to the optical imaging lens assembly of the above-mentioned embodiments will further be described below with reference to the drawings.

### Embodiment 1

An optical imaging lens assembly according to Embodiment 1 of the disclosure will be described below with reference to FIGS. 1-4C. FIGS. 1 and 2 show structural schematic diagrams of an optical imaging lens assembly with F-numbers of 1.39 and 2.04 according to Embodiment 1 of the disclosure respectively.

As shown in FIGS. 1 and 2, the optical imaging lens assembly sequentially includes from an object side to an image side: a first lens E1, a variable diaphragm STO, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a flat surface. The second lens E2 has a negative refractive power, an object-side surface S3 thereof is a convex surface, and an image-side surface S4 thereof is a concave surface. The third lens E3 has a negative refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a convex surface. The fifth lens E5 has a negative refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a concave surface. The seventh lens E7 has a negative refractive power, an object-side surface S13 thereof is a convex surface, and an image-side surface S14 thereof is a concave surface. The optical filter E8 has an object-side surface S15 and an image-side surface S16. Light from an object sequentially penetrates through each of the surfaces S1 to S16, and is finally imaged on the imaging surface S17.

Table 1 shows a basic parameter table of the optical imaging lens assembly of Embodiment 1, wherein the units of the curvature radius, the thickness/distance and the focal length are all millimeters (mm).

TABLE 1

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| S1 | Aspheric | 3.2521 | 0.8106 | 1.70 | 49.2 | 4.67 | −0.1271 |
| S2 | Spherical | 1.0000E+18 | 0.2048 | | | | |
| STO | Spherical | Infinite | −0.0548 | | | | |
| S3 | Aspheric | 5.1448 | 0.2550 | 1.68 | 19.2 | −7.94 | 4.9560 |
| S4 | Aspheric | 2.5779 | 0.4583 | | | | −0.0947 |
| S5 | Aspheric | 7.9504 | 0.2500 | 1.68 | 19.2 | −21.46 | 18.7134 |
| S6 | Aspheric | 5.0749 | 0.0900 | | | | −1.0000 |
| S7 | Aspheric | 8.0115 | 0.7270 | 1.57 | 37.3 | 11.63 | −1.0000 |
| S8 | Aspheric | −37.3741 | 0.5720 | | | | 0.0000 |
| S9 | Aspheric | 7.5862 | 0.4711 | 1.55 | 56.1 | −102.95 | 0.0000 |
| S10 | Aspheric | 6.5374 | 0.1973 | | | | −1.4274 |
| S11 | Aspheric | 2.3134 | 0.4469 | 1.55 | 56.1 | 5.97 | −1.0000 |
| S12 | Aspheric | 7.4292 | 0.6296 | | | | −1.0000 |
| S13 | Aspheric | 2.7520 | 0.4875 | 1.55 | 56.1 | −5.60 | −12.5728 |
| S14 | Aspheric | 1.3572 | 0.4112 | | | | −1.2139 |
| S15 | Spherical | Infinite | 0.1100 | 1.52 | 64.2 | | |
| S16 | Spherical | Infinite | 0.4835 | | | | |
| S17 | Spherical | Infinite | | | | | |

In the embodiment, a total effective focal length f of the optical imaging lens assembly is 4.86 mm. TTL is a total length of the optical imaging lens assembly (a distance from the object-side surface S1 of the first lens E1 to the imaging surface S17 of the optical imaging lens assembly on an optical axis), and TTL is 6.55 mm. ImgH is a half of a diagonal length of an effective pixel region on the imaging surface of the optical imaging lens assembly, and ImgH is 4.18 mm. FNOₘᵢₙ is a minimum value of an F-number of the optical imaging lens assembly, and FNOₘᵢₙ is 1.39. FNOₘₐₓ is a maximum value of the F-number of the optical imaging lens assembly, and FNOₘₐₓ is 2.04. A relative aperture of the optical imaging lens assembly is the maximum when the F-number is the minimum value. The relative aperture of the optical imaging lens assembly is the minimum when the F-number is the maximum value.

In Embodiment 1, the object-side surface S1 of the first lens E1 and the object-side surface and image-side surface of any lens in the second lens E2 to the seventh lens E7 are aspheric surfaces, and a surface type x of each aspheric lens may be defined through, but not limited to, the following aspheric surface formula:

$$x = \frac{{ch}^{2}}{1 + \sqrt{1 - ( k + 1 ) {c}^{2} {h}^{2}}} + \sum {Aih}^{i} , \qquad ( 1 )$$

wherein x is a distance vector height from a vertex of the aspheric surface when the aspheric surface is at a height of h along the optical axis direction; c is a paraxial curvature of the aspheric surface, c=1/R (namely, the paraxial curvature c is a reciprocal of the curvature radius R in Table 1 above); k is a conic coefficient; and Ai is a correction coefficient of the 1-th order of the aspheric surface. Tables 2-1 and 2-2 show higher-order coefficients A4, A6, A8, A10, A12, A14, A16, A18, A20, A22, A24, A26, A28 and A30 that can be used for each of the aspheric mirror surfaces S1 and S3-S14 in Embodiment 1.

TABLE 2−1

| Surface | | | | | | | |
|---|---|---|---|---|---|---|---|
| nurnber | A4 | AS | A8 | A10 | A12 | A14 | A16 |
| S1 | −4.7848E−03 | 1.6962E−02 | −5.7369E−02 | 1.2554E−01 | −1.9338E−01 | 2.1150E−01 | −1.6495E−01 |
| S3 | −4.8273E−02 | 5.4365E−02 | −1.9774E−01 | 6.7581E−01 | −1.5599E+00 | 2.4929E+00 | −2.8342E+00 |
| S4 | −5.0924E−02 | −1.2785E−02 | 1.8145E−01 | −6.5504E−01 | 1.4676E+00 | −2.1926E+00 | 2.2330E+00 |
| S5 | −4.1765E−02 | 9.8774E−02 | −5.1832E−01 | 1.5205E+00 | −3.0790E+00 | 4.4538E+00 | −4.6859E+00 |
| S6 | −4.0967E−02 | 9.6008E−02 | −3.0595E−01 | 6.4213E−01 | −9.6296E−01 | 1.0490E+00 | −8.2746E−01 |
| S7 | −4.2770E−02 | 8.2756E−02 | −1.9421E−01 | 3.3974E−01 | −3.9291E−01 | 2.7752E−01 | −8.2242E−02 |
| S8 | −2.8118E−02 | −7.0297E−02 | 3.7158E−01 | −1.1194E+00 | 2.2119E+00 | −3.0278E+00 | 2.9528E+00 |
| S9 | −2.3254E−02 | −5.1223E−02 | 1.0351E−01 | −6.8991E−02 | −7.2195E−02 | 2.0587E−01 | −2.2584E−01 |
| S10 | −2.8006E−02 | −2.0817E−01 | 3.8756E−01 | −4.2586E−01 | 3.3037E−01 | −1.9126E−01 | 8.4476E−02 |
| S11 | 5.6167E−02 | −1.5189E−01 | 1.6438E−01 | −1.4244E−01 | 9.9935E−02 | −5.4082E−02 | 2.1579E−02 |
| S12 | 6.4247E−02 | 2.2455E−02 | −1.3229E−01 | 1.4948E−01 | −9.5986E−02 | 4.0436E−02 | −1.1835E−02 |
| S13 | −1.6670E−01 | 6.2549E−02 | −2 3275E−02 | 7.9914E−03 | −1.0156E−03 | −4.0157E−04 | 2.2279E−04 |
| S14 | −2.5900E−01 | 1.6979E−01 | −1.0170E−01 | 4.9938E−02 | −1.8735E−02 | 5.2082E−03 | −1.0613E−03 |

TABLE 2−2

| Surface | | | | | | | |
|---|---|---|---|---|---|---|---|
| number | A18 | A20 | A22 | A24 | A26 | A28 | A30 |
| S1 | 9.1568E−02 | −3.5792E−02 | 9.6047E−03 | −1.6818E−03 | 1.7289E−04 | −7.9086E−06 | 0.0000E+00 |
| S3 | 2.3261E+00 | −1.3824E+00 | 5.8930E−01 | −1.7564E−01 | 3.4742E−02 | −4.0962E−03 | 2.1779E−04 |
| S4 | −1.5543E+00 | 7.2695E−01 | −2.1826E−01 | 3.7973E−02 | −2.9082E−03 | 0.0000E+00 | 0.0000E+00 |
| S5 | 3.6014E+00 | −2.0018E+00 | 7.8293E−01 | −2.0407E−01 | 3.1767E−02 | −2.2301E−03 | 0.0000E+00 |
| S6 | 4.6850E−01 | −1.8747E−01 | 5.1571E−02 | −9.2669E−03 | 9.8109E−04 | −4.6681E−05 | 0.0000E+00 |
| S7 | −4.0902E−02 | 5.5257E−02 | −2.6896E−02 | 7.0816E−03 | −9.9463E−04 | 5.8398E−05 | 0.0000E+00 |
| S8 | −2.0791E+00 | 1.0588E+00 | −3.8601E−01 | 9.8125E−02 | −1.6503E−02 | 1.6489E−03 | −7.4027E−05 |
| S9 | 1.5189E−01 | −6.8635E−02 | 2.1311E−02 | −4.4975E−03 | 6.1709E−04 | −4.9656E−05 | 1.7776E−06 |
| S10 | −2.8708E−02 | 7.4892E−03 | −1.4739E−03 | 2.1080E−04 | −2.0533E−05 | 1.2094E−06 | −3.2316E−08 |
| S11 | −6.2389E−03 | 1.2982E−03 | −1.9220E−04 | 1.9728E−05 | −1.3331E−06 | 5.3292E−08 | −9.5408E−10 |
| S12 | 2.4725E−03 | −3.7175E−04 | 3.9918E−05 | −2.9837E−06 | 1.4727E−07 | −4.3069E−09 | 5.6391E−11 |
| S13 | −5.2817E−05 | 7.6776E−06 | −7.3859E−07 | 4.7447E−08 | −1.9661E−09 | 4.7667E−11 | −5.1469E−13 |
| S14 | 1.5799E−04 | −1.7106E−05 | 1.3309E−06 | −7.2512E−08 | 2.6271E−09 | −5.6889E−11 | 5.5741E−13 |

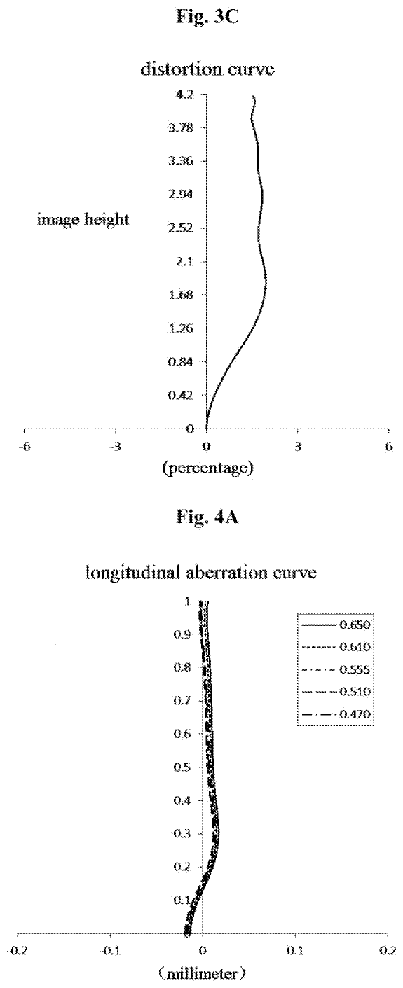

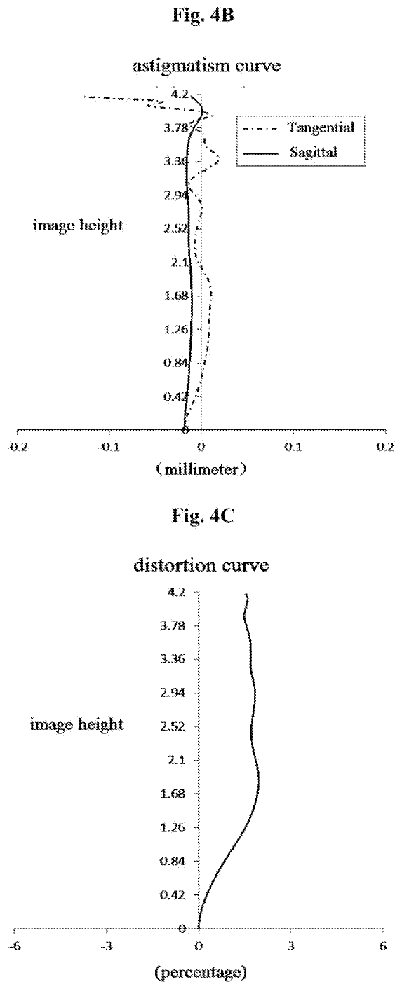

FIGS. 3A and 4A show longitudinal aberration curves of the optical imaging lens assembly with the F-numbers of 1.39 and 2.04 according to Embodiment 1 to represent deviations of a convergence focal point after light with different wavelengths passes through the lens respectively. FIGS. 3B and 4B show astigmatism curves of the optical imaging lens assembly with the F-numbers of 1.39 and 2.04 according to Embodiment 1 to represent a tangential image surface curvature and a sagittal image surface curvature respectively. FIGS. 3C and 4C show distortion curves of the optical imaging lens assembly with the F-numbers of 1.39 and 2.04 according to Embodiment 1 to represent distortion values corresponding to different image heights respectively. According to FIGS. 3A-4C, it can be seen that the optical imaging lens assembly provided in Embodiment 1 may achieve high imaging quality.

### Embodiment 2

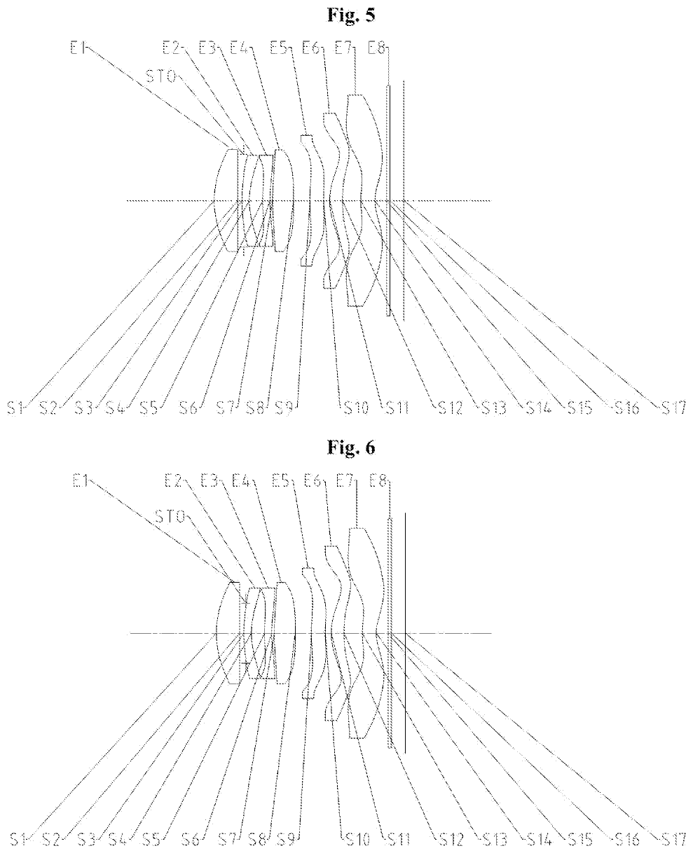

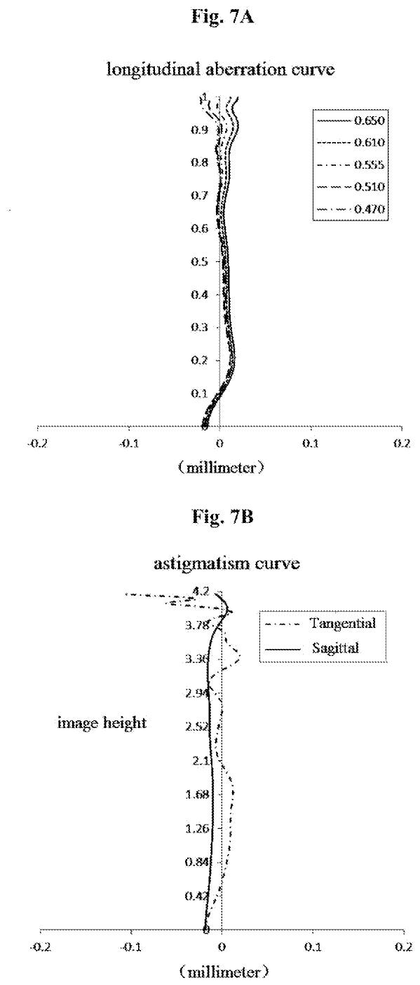

An optical imaging lens assembly according to Embodiment 2 of the disclosure will be described below with reference to FIGS. 5-8C. In the embodiment and the following embodiments, parts of descriptions similar to those about Embodiment 1 are omitted for simplicity. FIGS. 5 and 6 show structural schematic diagrams of an optical imaging lens assembly with F-numbers of 1.39 and 2.05 according to Embodiment 2 of the disclosure respectively.

As shown in FIGS. 5 and 6, the optical imaging lens assembly sequentially includes from an object side to an image side: a first lens E1, a variable diaphragm STO, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a flat surface. The second lens E2 has a negative refractive power, an object-side surface S3 thereof is a convex surface, and an image-side surface S4 thereof is a concave surface. The third lens E3 has a negative refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a convex surface. The fifth lens E5 has a negative refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a concave surface. The seventh lens E7 has a negative refractive power, an object-side surface S13 thereof is a convex surface, and an image-side surface S14 thereof is a concave surface. The optical filter E8 has an object-side surface S15 and an image-side surface S16. Light from an object sequentially penetrates through each of the surfaces S1 to S16, and is finally imaged on the imaging surface S17.

In the embodiment, a total effective focal length f of the optical imaging lens assembly is 4.86 mm. TTL is a total length of the optical imaging lens assembly, and TTL is 6.55 mm. ImgH is a half of a diagonal length of an effective pixel region on the imaging surface of the optical imaging lens assembly, and ImgH is 4.18 mm. FNOₘᵢₙ is a minimum value of an F-number of the optical imaging lens assembly, and FNOₘᵢₙ is 1.39. FNOₘₐₓ is a maximum value of the F-number of the optical imaging lens assembly, and FNOₘₐₓ is 2.05. A relative aperture of the optical imaging lens assembly is the maximum when the F-number is the minimum value. The relative aperture of the optical imaging lens assembly is the minimum when the F-number is the maximum value.

Table 3 shows a basic parameter table of the optical imaging lens assembly of Embodiment 2, wherein the units of the curvature radius, the thickness/distance and the focal length are all millimeters (mm). Tables 4-1 and 4-2 show high-order coefficients that can be used for each aspheric mirror surface in Embodiment 2. A surface type of each aspheric surface may be defined by formula (1) given in Embodiment 1.

TABLE 3

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| S1 | Aspheric | 3.2513 | 0.8081 | 1.70 | 49.2 | 4.67 | −0.1286 |
| S2 | Spherical | 1.0000E+18 | 0.2046 | | | | |
| STO | Spherical | Infinite | −0.0546 | | | | |
| S3 | Aspheric | 5.1890 | 0.2550 | 1.68 | 19.2 | −7.97 | 5.0548 |
| S4 | Aspheric | 2.5937 | 0.4587 | | | | −0.0911 |
| S5 | Aspheric | 7.8242 | 0.2500 | 1.68 | 19.2 | −20.83 | 21.1659 |
| S6 | Aspheric | 4.9684 | 0.0900 | | | | −1.0000 |
| S7 | Aspheric | 8.0116 | 0.7245 | 1.57 | 37.3 | 11.66 | −1.0000 |
| S8 | Aspheric | −37.9560 | 0.5639 | | | | 0.0000 |
| S9 | Aspheric | 7.4321 | 0.4747 | 1.55 | 56.1 | −216.97 | 0.0000 |
| 510 | Aspheric | 6.8356 | 0.2095 | | | | −1.1946 |
| 511 | Aspheric | 2.3553 | 0.4453 | 1.55 | 56.1 | 6.09 | −1.0000 |
| S12 | Aspheric | 7.5475 | 0.6289 | | | | −1.0000 |
| S13 | Aspheric | 2.7486 | 0.4850 | 1.55 | 56.1 | −5.57 | −12.5486 |
| S14 | Aspheric | 1.3539 | 0.4120 | | | | −1.2139 |
| S15 | Spherical | Infinite | 0.1100 | 1.52 | 64.2 | | |
| S16 | Spherical | Infinite | 0.4843 | | | | |
| S17 | Spherical | Infinite | | | | | |

TABLE 4−1

Surface

| number | A4 | A6 | A8 | A10 | A12 | A14 | A16 |
|---|---|---|---|---|---|---|---|
| S1 | −4.9863E−03 | 1.8618E−02 | −6.4308E−02 | 1.4308E−01 | −2.2263E−01 | 2.4505E−01 | −1.9201E−01 |
| S3 | −4.7633E−02 | 5.1862E−02 | −1.8812E−01 | 6.6047E−01 | −1.5630E+00 | 2.5505E+00 | −2.9498E+00 |
| S4 | −5.1340E−02 | −9.0552E−03 | 1.6267E−01 | −5.9091E−01 | 1.3235E+00 | −1.9754E+00 | 2.0103E+00 |
| S5 | −4.4593E−02 | 9.1661E−02 | −4.6992E−01 | 1.3295E+00 | −2.6039E+00 | 3.6690E+00 | −3.7928E+00 |
| S6 | −4.1880E−02 | 9.3213E−02 | −3.0158E−01 | 6.4702E−01 | −1.0113E+00 | 1.1726E+00 | −9.9994E−01 |
| S7 | −4.1254E−02 | 8.4082E−02 | −2.1479E−01 | 4.1800E−01 | −5.7148E−01 | 5.4150E−01 | −3.4383E−01 |
| S8 | −2.8175E−02 | −6.5269E−02 | 3.4535E−01 | −1.0363E+00 | 2.0416E+00 | −2.7913E+00 | 2.7233E+00 |
| S9 | −2.3808E−02 | −5.2377E−02 | 1.0653E−01 | −7.1865E−02 | −7.1241E−02 | 2.0706E−01 | −2.2799E−01 |
| S10 | −2.4718E−02 | −2.1143E−01 | 3.9059E−01 | −4.2792E−01 | 3.3143E−01 | −1.9171E−01 | 8.4645E−02 |
| S11 | 6.2021E−02 | −1.5556E−01 | 1.6445E−01 | −1.4040E−01 | 9.7666E−02 | −5.2568E−02 | 2.0883E−02 |
| S12 | 6.8744E−02 | 1.7348E−02 | −1.2803E−01 | 1.4623E−01 | −9.3962E−02 | 3.9511E−02 | −1.1533E−02 |
| S13 | −1.6494E−01 | 6.1667E−02 | −2.2956E−02 | 7.8596E−03 | −1.0007E−03 | −3.8495E−04 | 2.1342E−04 |
| S14 | −2.5987E−01 | 1.7241E−01 | −1.0525E−01 | 5.2705E−02 | −2.0119E−02 | 5.6764E−03 | −1.1721E−03 |

TABLE 4−2

| Surface | | | | | | | |
|---|---|---|---|---|---|---|---|
| number | A18 | A20 | A22 | A24 | A26 | A28 | A30 |
| S1 | 1.0700E−01 | −4.1969E−02 | 1.1300E−02 | −1.9855E−03 | 2.0480E−04 | −9.4013E−06 | 0.0000E+00 |
| S3 | 2.4548E+00 | −1.4752E+00 | 6.3462E−01 | −1.9058E−01 | 3.7947E−02 | −4.5014E−03 | 2.4076E−04 |
| S4 | −1.3990E+00 | 6.5452E−01 | −1.9667E−01 | 3.4258E−02 | −2.6277E−03 | 0.0000E+00 | 0.0000E+00 |
| S5 | 2.8888E+00 | −1.6035E+00 | 6.3002E−01 | −1.6566E−01 | 2.6080E−02 | −1.8539E−03 | 0.0000E+00 |
| S6 | 6.1925E−01 | −2.7386E−01 | 8.4143E−02 | −1.7069E−02 | 2.0592E−03 | −1.1220E−04 | 0.0000E+00 |
| S7 | 1.3635E−01 | −2.7173E−02 | −1.0037E−03 | 1.8310E−03 | −3.7400E−04 | 2.5917E−05 | 0.0000E+00 |
| S8 | −1.9207E+00 | 9.8060E−01 | −3.5860E−01 | 9.1476E−02 | −1.5442E−02 | 1.5488E−03 | −6.9804E−05 |
| S9 | 1.5367E−01 | −6.9564E−02 | 2.1637E−02 | −4.5738E−03 | 6.2859E−04 | −5.0664E−05 | 1.8167E−06 |
| S10 | −2.8765E−02 | 7.5049E−03 | −1.4771E−03 | 2.1129E−04 | −2.0582E−05 | 1.2124E−06 | −3.2398E−08 |
| S11 | −6.0129E−03 | 1.2461E−03 | −1.8373E−04 | 1.8782E−05 | −1.2640E−06 | 5.0322E−08 | −8.9724E−10 |
| S12 | 2.4022E−03 | −3.6005E−04 | 3.8539E−05 | −2.8716E−06 | 1.4129E−07 | −4.1192E−09 | 5.3767E−11 |
| S13 | −5.0356E−05 | 7.2820E−06 | −6.9684E−07 | 4.4529E−08 | −1.8354E−09 | 4.4264E−11 | −4.7543E−13 |
| S14 | 1.7663E−04 | −1.9346E−05 | 1.5218E−06 | −8.3769E−08 | 3.0638E−09 | −6.6911E−11 | 6.6048E−13 |

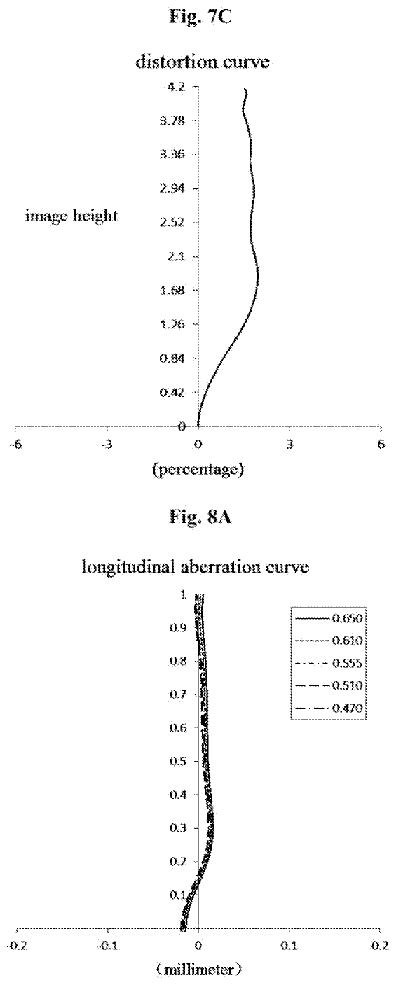

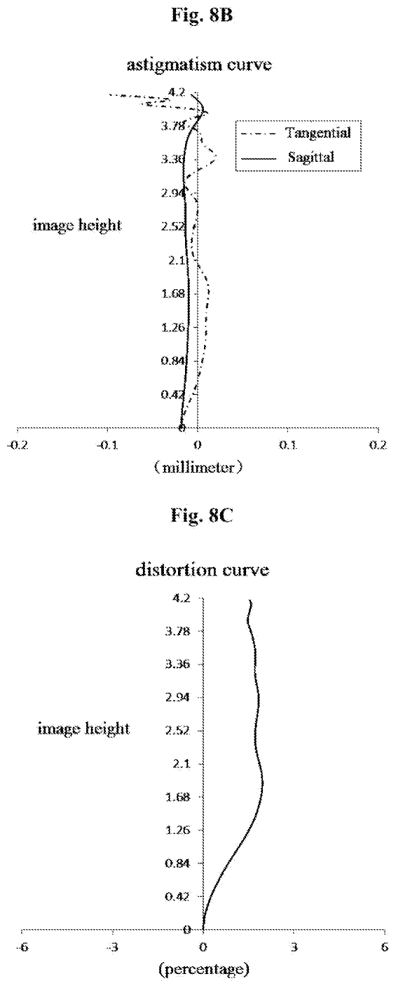

FIGS. 7A and 8A show longitudinal aberration curves of the optical imaging lens assembly with the F-numbers of 1.39 and 2.05 according to Embodiment 2 to represent deviations of a convergence focal point after light with different wavelengths passes through the lens respectively. FIGS. 7B and 8B show astigmatism curves of the optical imaging lens assembly with the F-numbers of 1.39 and 2.05 according to Embodiment 2 to represent a tangential image surface curvature and a sagittal image surface curvature respectively. FIGS. 7C and 8C show distortion curves of the optical imaging lens assembly with the F-numbers of 1.39 and 2.05 according to Embodiment 2 to represent distortion values corresponding to different image heights respectively. According to FIGS. 7A-8C, it can be seen that the optical imaging lens assembly provided in Embodiment 2 may achieve high imaging quality.

### Embodiment 3

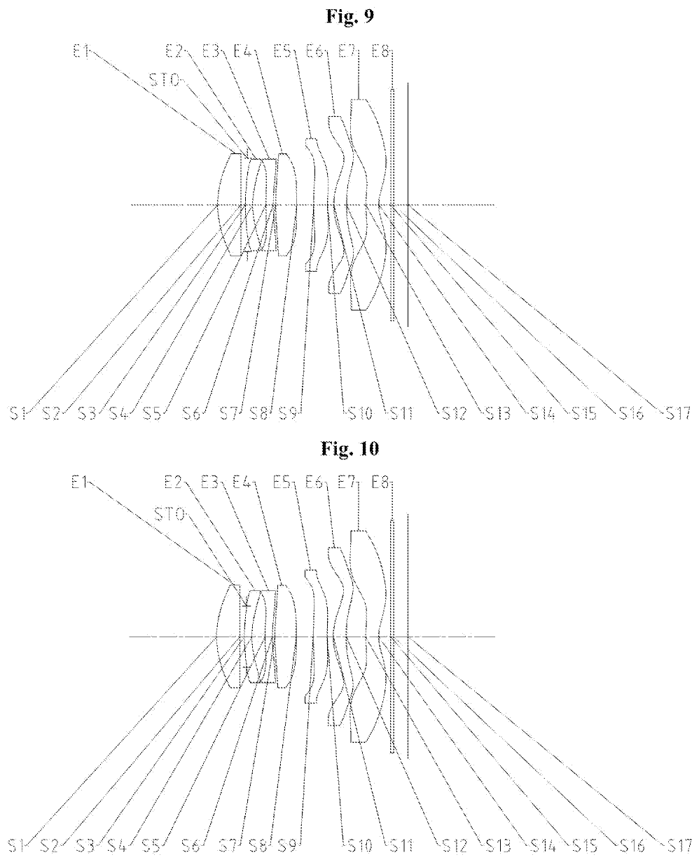

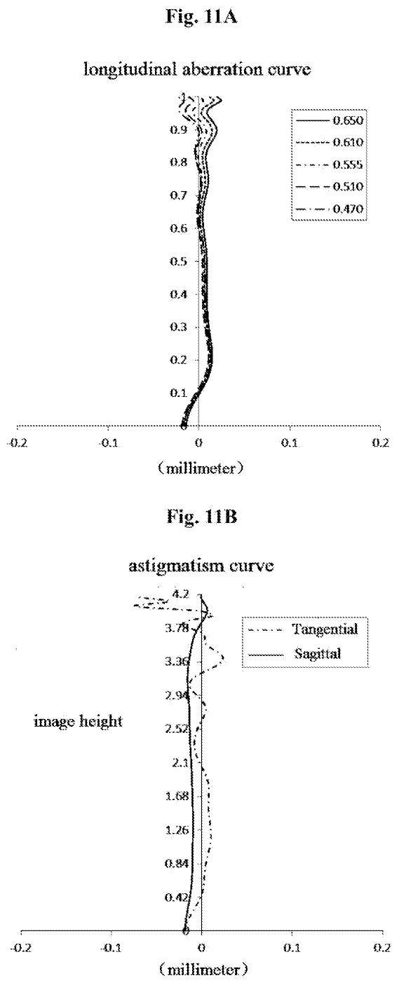

An optical imaging lens assembly according to Embodiment 3 of the disclosure will be described below with reference to FIGS. 9-12C. FIGS. 9 and 10 show structural schematic diagrams of an optical imaging lens assembly with F-numbers of 1.39 and 2.04 according to Embodiment 3 of the disclosure respectively.

As shown in FIGS. 9 and 10, the optical imaging lens assembly sequentially includes from an object side to an image side: a first lens E1, a variable diaphragm STO, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a flat surface. The second lens E2 has a negative refractive power, an object-side surface S3 thereof is a convex surface, and an image-side surface S4 thereof is a concave surface. The third lens E3 has a negative refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a convex surface. The fifth lens E5 has a positive refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a concave surface. The seventh lens E7 has a negative refractive power, an object-side surface S13 thereof is a convex surface, and an image-side surface S14 thereof is a concave surface. The optical filter E8 has an object-side surface S15 and an image-side surface S16. Light from an object sequentially penetrates through each of the surfaces S1 to S16, and is finally imaged on the imaging surface S17.

In the embodiment, a total effective focal length f of the optical imaging lens assembly is 4.86 mm. TTL is a total length of the optical imaging lens assembly, and TTL is 6.55 mm. ImgH is a half of a diagonal length of an effective pixel region on the imaging surface of the optical imaging lens assembly, and ImgH is 4.18 mm. FNOₘᵢₙ is a minimum value of an F-number of the optical imaging lens assembly, and FNOₘᵢₙ is 1.39. FNOₘₐₓ is a maximum value of the F-number of the optical imaging lens assembly, and FNOₘₐₓ is 2.04. A relative aperture of the optical imaging lens assembly is the maximum when the F-number is the minimum value. The relative aperture of the optical imaging lens assembly is the minimum when the F-number is the maximum value.

Table 5 shows a basic parameter table of the optical imaging lens assembly of Embodiment 3, wherein the units of the curvature radius, the thickness/distance and the focal length are all millimeters (mm). Tables 6-1 and 6-2 show high-order coefficients that can be used for each aspheric mirror surface in Embodiment 3. A surface type of each aspheric surface may be defined by formula (1) given in Embodiment 1.

TABLE 5

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| S1 | Aspheric | 3.2582 | 0.8001 | 1.70 | 49.2 | 4.68 | −0.1451 |
| S2 | Spherical | 1.0000E+18 | 0.2231 | | | | |
| STO | Spherical | Infinite | −0.0731 | | | | |
| S3 | Aspheric | 5.7258 | 0.2550 | 1.68 | 19.2 | −8.08 | 6.5129 |
| S4 | Aspheric | 2.7478 | 0.4533 | | | | 0.0080 |
| S5 | Aspheric | 7.8224 | 0.2500 | 1.68 | 19.2 | −20.05 | 15.1032 |
| S6 | Aspheric | 4.8999 | 0.0900 | | | | −1.0000 |
| S7 | Aspheric | 8.5359 | 0.7274 | 1.57 | 37.3 | 11.44 | −1.0000 |
| S8 | Aspheric | −26.8568 | 0.5793 | | | | 0.0000 |
| S9 | Aspheric | 7.8232 | 0.4812 | 1.55 | 56.1 | 98.37 | 0.0000 |
| 510 | Aspheric | 8.9583 | 0.2128 | | | | 0.6433 |
| 511 | Aspheric | 2.4813 | 0.4404 | 1.55 | 56.1 | 6.65 | −14.2611 |
| S12 | Aspheric | 7.3476 | 0.6599 | | | | −1.0000 |
| 313 | Aspheric | 2.6779 | 0.4500 | 1.55 | 56.1 | −5.42 | −13.5671 |
| S14 | Aspheric | 1.3229 | 0.4091 | | | | −1.2130 |
| S15 | Spherical | Infinite | 0.1100 | 1.52 | 64.2 | | |
| 316 | Spherical | Infinite | 0.4814 | | | | |
| S17 | Spherical | Infinite | | | | | |

TABLE 6−1

| Surface | | | | | | | |
|---|---|---|---|---|---|---|---|
| number | A4 | A6 | A8 | A10 | A12 | A14 | A16 |
| S1 | −4.8883E−03 | 1.8142E−02 | −6.6610E−02 | 1.5637E−01 | −2.5392E−01 | 2.8905E−01 | −2.3266E−01 |
| S3 | −4.1585E−02 | 4.4079E−02 | −1.5481E−01 | 5.3990E−01 | −1.2594E+00 | 2.0087E+00 | −2.2539E+00 |
| S4 | −4.6808E−02 | −9.5999E−03 | 1.4569E−01 | −5.1701E−01 | 1.1433E+00 | −1.6973E+00 | 1.7285E+00 |
| S5 | −3.9110E−02 | 1.5993E−02 | −1.1997E−01 | 2.7053E−01 | −3.8180E−01 | 3.6725E−01 | −2.7897E−01 |
| S6 | −2.5558E−02 | −8.5712E−03 | 3.0620E−02 | −8.1326E−02 | 1.0316E−01 | −3.4060E−02 | −7.0737E−02 |
| S7 | −2.3205E−02 | 2.1812E−02 | −6.0565E−02 | 1.6443E−01 | −2.9242E−01 | 3.4007E−01 | −2.5731E−01 |
| S8 | −1.7706E−02 | −1.1403E−01 | 5.2674E−01 | −1.5115E+00 | 2.9124E+00 | −3.9255E+00 | 3.7904E+00 |
| S9 | −6.9482E−05 | −8.8993E−02 | 1.4957E−01 | −1.0809E−01 | −4.6155E−02 | 1.8882E−01 | −2.1376E−01 |
| S10 | 2.0102E−02 | −2.5958E−01 | 4.1737E−01 | −4.2307E−01 | 3.0893E−01 | −1.7065E−01 | 7.2758E−02 |
| S11 | 1.9418E−01 | −2.7870E−01 | 2.7179E−01 | −2.1822E−01 | 1.4096E−01 | −7.0494E−02 | 2.6365E−02 |
| S12 | 7.3675E−02 | 1.5981E−02 | −1.2483E−01 | 1.3886E−01 | −8.7292E−02 | 3.6065E−02 | −1.0368E−02 |
| S13 | −1.7357E−01 | 7.1985E−02 | −2.9081E−02 | 9.8783E−03 | −1.3429E−03 | −3.9385E−04 | 2.3514E−04 |
| S14 | −2.8338E−01 | 2.0110E−01 | −1.2840E−01 | 6.5845E−02 | −2.5489E−02 | 7.2775E−03 | −1.5224E−03 |

TABLE 6−2

| Surface | | | | | | | |
|---|---|---|---|---|---|---|---|
| number | A18 | A20 | A22 | A24 | A26 | A28 | A30 |
| S1 | 1.3258E−01 | −5.3008E−02 | 1.4517E−02 | −2.5901E−03 | 2.7102E−04 | −1.2609E−05 | 0.0000E+00 |
| S3 | 1.8091E+00 | −1.0442E+00 | 4.3040E−01 | −1.2380E−01 | 2.3644E−02 | −2.6991E−03 | 1.3959E−04 |
| S4 | −1.2095E+00 | 5.7105E−01 | −1.7361E−01 | 3.0649E−02 | −2.3851E−03 | 0.0000E+00 | 0.0000E+00 |
| S5 | 2.0838E−01 | −1.5276E−01 | 8.7037E−02 | −3.2166E−02 | 6.7026E−03 | −5.9652E−04 | 0.0000E+00 |
| S6 | 1.1228E−01 | −8.0948E−02 | 3.4607E−02 | −9.0138E−03 | 1.3298E−03 | −8.5677E−05 | 0.0000E+00 |
| S7 | 1.2305E−01 | −3.3971E−02 | 3.5804E−03 | 6.4048E−04 | −2.2372E−04 | 1.8417E−05 | 0.0000E+00 |
| S8 | −2.6529E+00 | 1.3470E+00 | −4.9081E−01 | 1.2496E−01 | −2.1089E−02 | 2.1176E−03 | −9.5686E−05 |
| S9 | 1.4433E−01 | −6.5093E−02 | 2.0146E−02 | −4.2363E−03 | 5.7910E−04 | −4.6424E−05 | 1.6556E−06 |
| S10 | −2.4068E−02 | 6.1379E−03 | −1.1825E−03 | 1.6559E−04 | −1.5791E−05 | 9.1056E−07 | −2.3822E−08 |
| S11 | −7.2431E−03 | 1.4462E−03 | −2.0682E−04 | 2.0604E−05 | −1.3561E−06 | 5.2947E−08 | −9.2786E−10 |
| S12 | 2.1294E−03 | −3.1488E−04 | 3.3258E−05 | −2.4456E−06 | 1.1876E−07 | −3.4171E−09 | 4.4025E−11 |
| S13 | −5.6587E−05 | 8.3002E−06 | −8.0487E−07 | 5.2111E−08 | −2.1762E−09 | 5.3176E−11 | −5.7869E−13 |
| S14 | 2.3292E−04 | −2.5952E−05 | 2.0802E−06 | −1.1680E−07 | 4.3608E−09 | −9.7246E−11 | 9.8014E−13 |

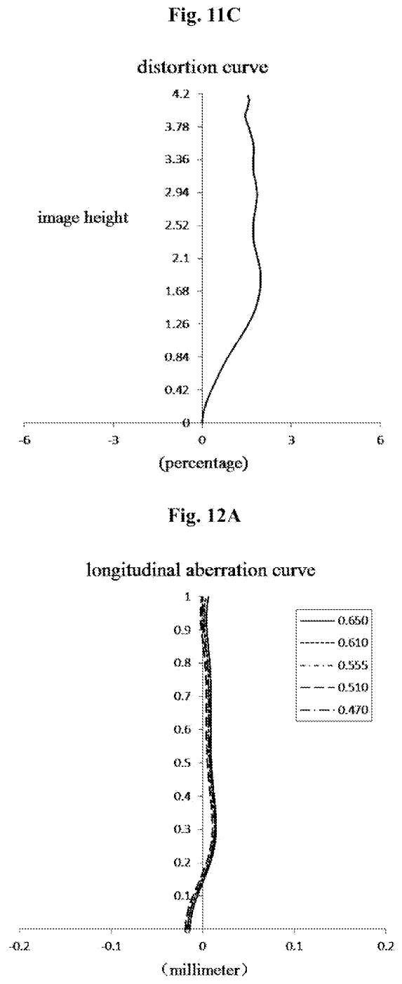

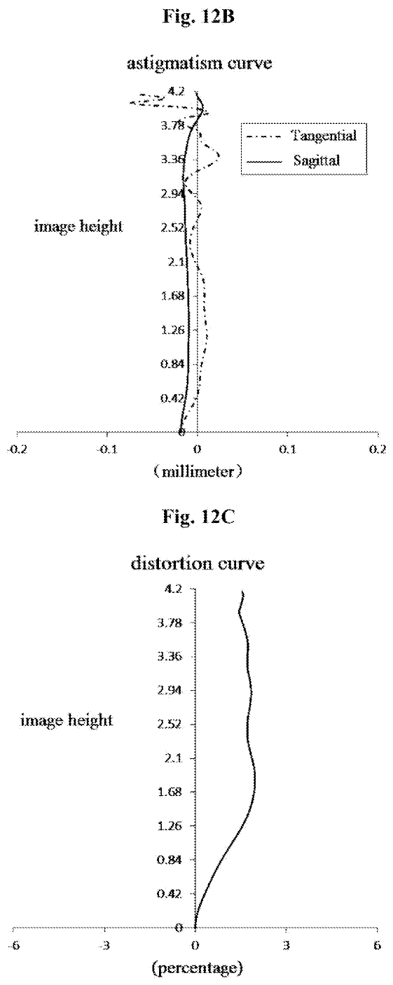

FIGS. 11A and 12A show longitudinal aberration curves of the optical imaging lens assembly with the F-numbers of 1.39 and 2.04 according to Embodiment 3 to represent deviations of a convergence focal point after light with different wavelengths passes through the lens respectively. FIGS. 11B and 12B show astigmatism curves of the optical imaging lens assembly with the F-numbers of 1.39 and 2.04 according to Embodiment 3 to represent a tangential image surface curvature and a sagittal image surface curvature respectively. FIGS. 11C and 12C show distortion curves of the optical imaging lens assembly with the F-numbers of 1.39 and 2.04 according to Embodiment 3 to represent distortion values corresponding to different image heights respectively. According to FIGS. 11A-12C, it can be seen that the optical imaging lens assembly provided in Embodiment 3 may achieve high imaging quality.

### Embodiment 4

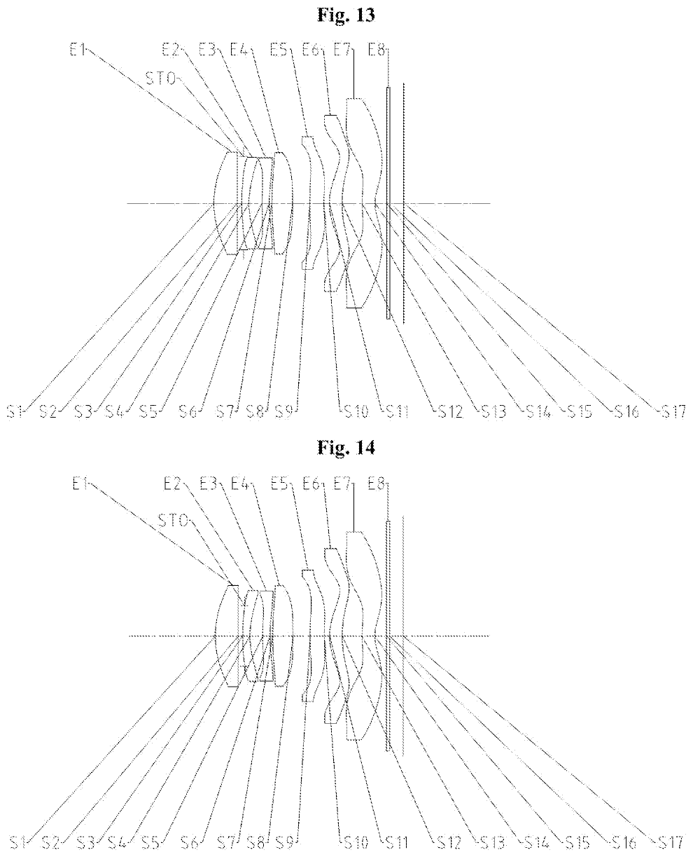

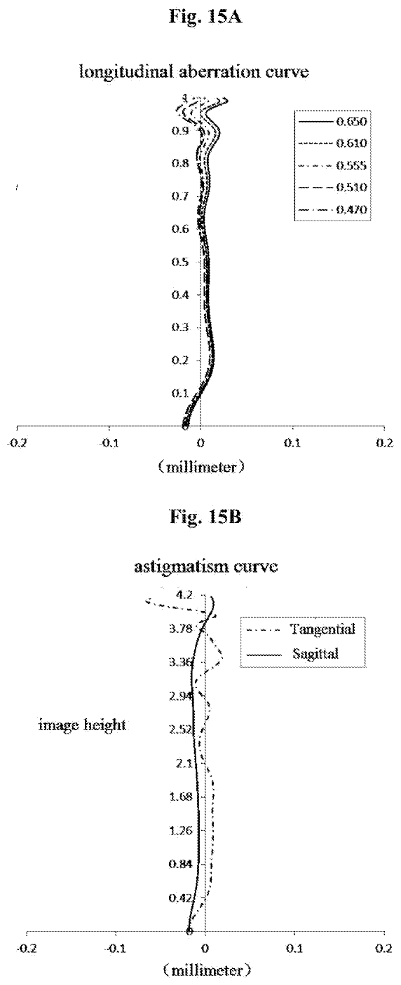

An optical imaging lens assembly according to Embodiment 4 of the disclosure will be described below with reference to FIGS. 13-16C. FIGS. 13 and 14 show structural schematic diagrams of an optical imaging lens assembly with F-numbers of 1.39 and 2.04 according to Embodiment 4 of the disclosure respectively.

As shown in FIGS. 13 and 14, the optical imaging lens assembly sequentially includes from an object side to an image side: a first lens E1, a variable diaphragm STO, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a flat surface. The second lens E2 has a negative refractive power, an object-side surface S3 thereof is a convex surface, and an image-side surface S4 thereof is a concave surface. The third lens E3 has a negative refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a convex surface. The fifth lens E5 has a positive refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a concave surface. The seventh lens E7 has a negative refractive power, an object-side surface S13 thereof is a convex surface, and an image-side surface S14 thereof is a concave surface. The optical filter E8 has an object-side surface S15 and an image-side surface S16. Light from an object sequentially penetrates through each of the surfaces S1 to S16, and is finally imaged on the imaging surface S17.

In the embodiment, a total effective focal length f of the optical imaging lens assembly is 4.87 mm. TTL is a total length of the optical imaging lens assembly, and TTL is 6.55 mm. ImgH is a half of a diagonal length of an effective pixel region on the imaging surface of the optical imaging lens assembly, and ImgH is 4.18 mm. FNOₘᵢₙ is a minimum value of an F-number of the optical imaging lens assembly, and FNOₘᵢₙ is 1.39. FNOₘₐₓ is a maximum value of the F-number of the optical imaging lens assembly, and FNOₘₐₓ is 2.04. A relative aperture of the optical imaging lens assembly is the maximum when the F-number is the minimum value. The relative aperture of the optical imaging lens assembly is the minimum when the F-number is the maximum value.

Table 7 shows a basic parameter table of the optical imaging lens assembly of Embodiment 4, wherein the units of the curvature radius, the thickness/distance and the focal length are all millimeters (mm). Tables 8-1 and 8-2 show high-order coefficients that can be used for each aspheric mirror surface in Embodiment 4. A surface type of each aspheric surface may be defined by formula (1) given in Embodiment 1.

TABLE 7

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| S1 | Aspheric | 3.2484 | 0.8046 | 1.70 | 49.2 | 4.67 | −0.1550 |
| S2 | Spherical | 1.0000E+18 | 0.2200 | | | | |
| STO | Spherical | Infinite | −0.0700 | | | | |
| S3 | Aspheric | 5.9906 | 0.2550 | 1.68 | 19.2 | −8.07 | 7.3508 |
| S4 | Aspheric | 2.8094 | 0.4485 | | | | 0.0800 |
| S5 | Aspheric | 8.0908 | 0.2500 | 1.68 | 19.2 | −21.10 | 14.2438 |
| S6 | Aspheric | 5.1024 | 0.0900 | | | | −1.0000 |
| S7 | Aspheric | 8.6610 | 0.7132 | 1.57 | 37.3 | 11.81 | −1.0000 |
| S8 | Aspheric | −29.3609 | 0.5941 | | | | 0.0000 |
| S9 | Aspheric | 8.7926 | 0.4908 | 1.55 | 56.1 | 709.23 | 0.0000 |
| S10 | Aspheric | 8.8196 | 0.1906 | | | | 0.5846 |
| S11 | Aspheric | 2.2820 | 0.4414 | 1.55 | 56.1 | 6.50 | −3.8101 |
| S12 | Aspheric | 5.9590 | 0.6797 | | | | −1.0000 |
| S13 | Aspheric | 2.6282 | 0.4500 | 1.55 | 56.1 | −5.56 | −12.8947 |
| S14 | Aspheric | 1.3235 | 0.4049 | | | | −1.2128 |
| S15 | Spherical | Infinite | 0.1100 | 1.52 | 64.2 | | |
| S16 | Spherical | Infinite | 0.4772 | | | | |
| S17 | Spherical | Infinite | | | | | |

TABLE 8−1

| Surface | | | | | | | |
|---|---|---|---|---|---|---|---|
| number | A4 | A6 | A8 | A10 | A12 | A14 | A16 |
| S1 | −4.5246E−03 | 1.4961E−02 | −5.3078E−02 | 1.2282E−01 | −2.0007E−01 | 2.2998E−01 | −1.8721E−01 |
| S3 | −4.0246E−02 | 4.0403E−02 | −1.3791E−01 | 4.9888E−01 | −1.2063E+00 | 1.9905E+00 | −2.3080E+00 |
| S4 | −4.6733E−02 | −6.5614E−03 | 1.2979E−01 | −4.6771E−01 | 1.0463E+00 | −1.5697E+00 | 1.6148E+00 |
| S5 | −3.2037E−02 | −9.8957E−03 | −1.7784E−02 | −3.8174E−02 | 2.9841E−01 | −7.0667E−01 | 9.3002E−01 |
| S6 | −1.3448E−02 | −4.6054E−02 | 1.2882E−01 | −2.7138E−01 | 3.7152E−01 | −3.0026E−01 | 1.0537E−01 |
| S7 | −1.8103E−02 | 1.0303E−02 | −6.7531E−02 | 2.6111E−01 | −5.5596E−01 | 7.5917E−01 | −7.0017E−01 |
| S8 | −1.5251E−02 | −1.3220E−01 | 6.2525E−01 | −1.8546E+00 | 3.6835E+00 | −5.0984E+00 | 5.0400E+00 |
| S9 | 4.8951E−03 | −8.2312E−02 | 1.3283E−01 | −9.2711E−02 | −4.9469E−02 | 1.7979E−01 | −2.0039E−01 |
| S10 | 1.1038E−02 | −2.4084E−01 | 3.9684E−01 | −4.0863E−01 | 3.0178E−01 | −1.6786E−01 | 7.1793E−02 |
| S11 | 9.3107E−02 | −1.6436E−01 | 1.6499E−01 | −1.3900E−01 | 9.6159E−02 | −5.1473E−02 | 2.0347E−02 |
| S12 | 5.5554E−02 | 2.8276E−02 | −1.3398E−01 | 1.4585E−01 | −9.1501E−02 | 3.7926E−02 | −1.0962E−02 |
| S13 | −1.8526E−01 | 8.0407E−02 | −3.4359E−02 | 1.2270E−02 | −1.7604E−03 | −5.2220E−04 | 3.2824E−04 |
| S14 | −2.8571E−01 | 1.9647E−01 | −1.1947E−01 | 5.8243E−02 | −2.1565E−02 | 5.9420E−03 | −1.2096E−03 |

TABLE 8−2

| Surface | | | | | | | |
|---|---|---|---|---|---|---|---|
| number | A18 | A20 | A22 | A24 | A26 | A28 | A30 |
| S1 | 1.0781E−01 | −4.3498E−02 | 1.2001E−02 | −2.1539E−03 | 2.2640E−04 | −1.0569E−05 | 0.0000E+00 |
| S3 | 1.9133E+00 | −1.1406E+00 | 4.8576E−01 | −1.4441E−01 | 2.8511E−02 | −3.3631E−03 | 1.7956E−04 |
| S4 | −1.1412E+00 | 5.4403E−01 | −1.6694E−01 | 2.9733E−02 | −2.3331E−03 | 0.0000E+00 | 0.0000E+00 |
| S5 | −7.5832E−01 | 3.9035E−01 | −1.2212E−01 | 2.0347E−02 | −1.0345E−03 | −8.9274E−05 | 0.0000E+00 |
| S6 | 4.2417E−02 | −7.0674E−02 | 3.8772E−02 | −1.1529E−02 | 1.8526E−03 | −1.2670E−04 | 0.0000E+00 |
| S7 | 4.4497E−01 | −1.9547E−01 | 5.8454E−02 | −1.1404E−02 | 1.3156E−03 | −6.8527E−05 | 0.0000E+00 |
| S8 | −3.6025E+00 | 1.8646E+00 | −6.9156E−01 | 1.7901E−01 | −3.0686E−02 | 3.1279E−03 | −1.4341E−04 |
| S9 | 1.3411E−01 | −6.0021E−02 | 1.8437E−02 | −3.8476E−03 | 5.2196E−04 | −4.1524E−05 | 1.4695E−06 |
| S10 | −2.3762E−02 | 6.0554E−03 | −1.1652E−03 | 1.6294E−04 | −1.5517E−05 | 8.9358E−07 | −2.3346E−08 |
| S11 | −5.8337E−03 | 1.2045E−03 | −1.7697E−04 | 1.8029E−05 | −1.2092E−06 | 4.7981E−08 | −8.5266E−10 |
| S12 | 2.2658E−03 | −3.3727E−04 | 3.5863E−05 | −2.6546E−06 | 1.2976E−07 | −3.7579E−09 | 4.8725E−11 |
| S13 | −8.2483E−05 | 1.2619E−05 | −1.2761E−06 | 8.6155E−08 | −3.7520E−09 | 9.5602E−11 | −1.0849E−12 |
| S14 | 1.8129E−04 | −1.9882E−05 | 1.5740E−06 | −8.7516E−08 | 3.2420E−09 | −7.1853E−11 | 7.2086E−13 |

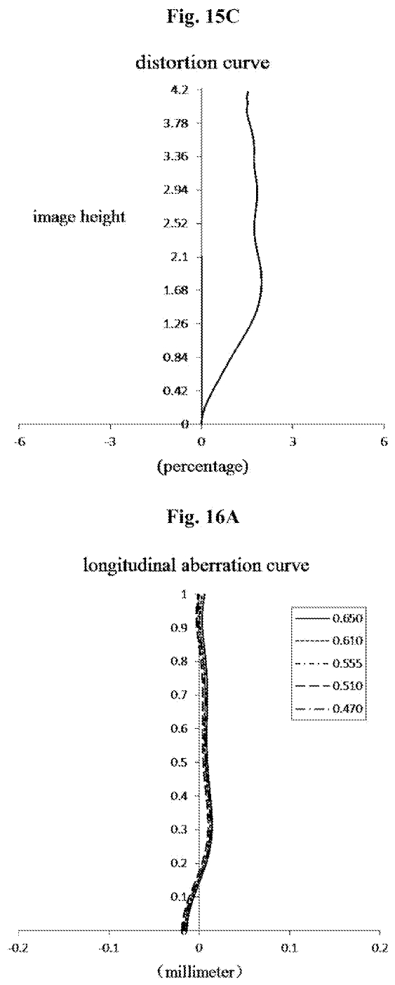

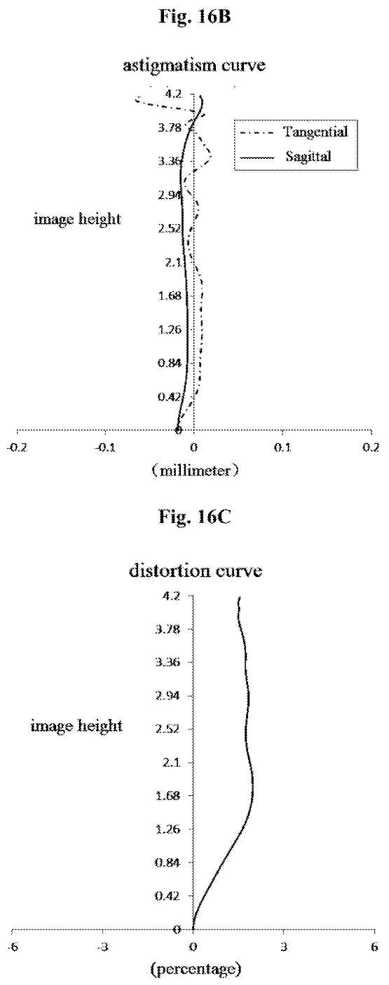

FIGS. 15A and 16A show longitudinal aberration curves of the optical imaging lens assembly with the F-numbers of 1.39 and 2.04 according to Embodiment 4 to represent deviations of a convergence focal point after light with different wavelengths passes through the lens respectively. FIGS. 15B and 16B show astigmatism curves of the optical imaging lens assembly with the F-numbers of 1.39 and 2.04 according to Embodiment 4 to represent a tangential image surface curvature and a sagittal image surface curvature respectively. FIGS. 15C and 16C show distortion curves of the optical imaging lens assembly with the F-numbers of 1.39 and 2.04 according to Embodiment 4 to represent distortion values corresponding to different image heights respectively. According to FIGS. 15A-16C, it can be seen that the optical imaging lens assembly provided in Embodiment 4 may achieve high imaging quality.

### Embodiment 5

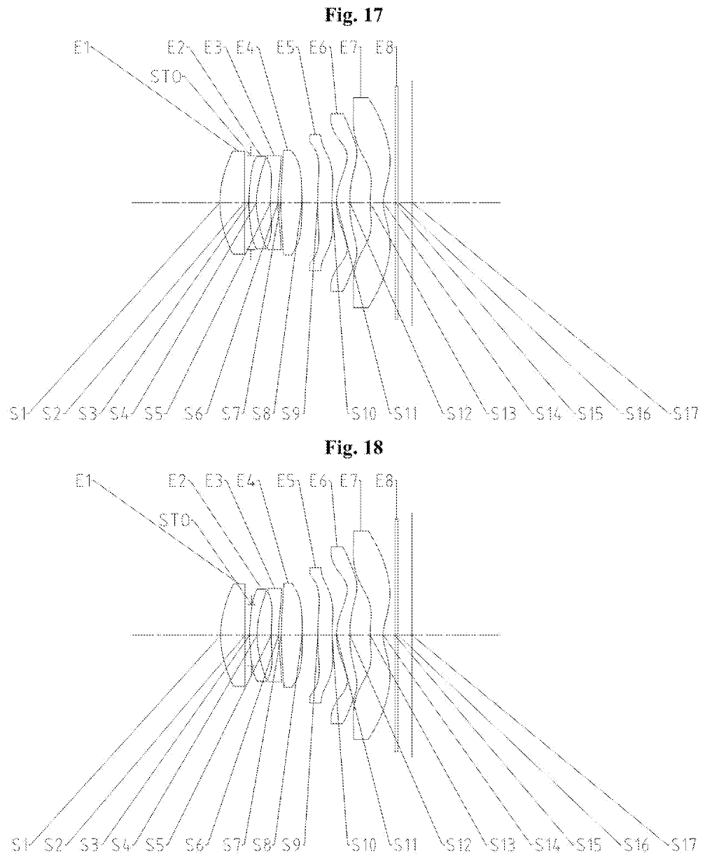

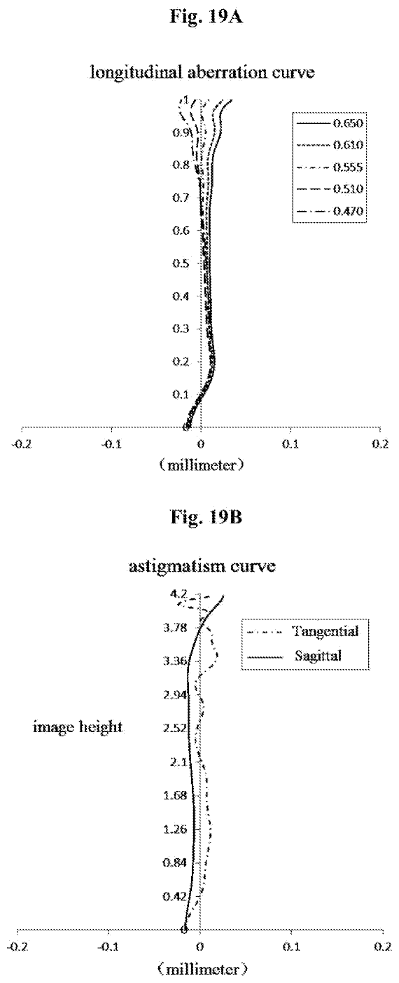

An optical imaging lens assembly according to Embodiment 5 of the disclosure will be described below with reference to FIGS. 17-20C. FIGS. 17 and 18 show structural schematic diagrams of an optical imaging lens assembly with F-numbers of 1.40 and 2.04 according to Embodiment 5 of the disclosure respectively.

As shown in FIGS. 17 and 18, the optical imaging lens assembly sequentially includes from an object side to an image side: a first lens E1, a variable diaphragm STO, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a flat surface. The second lens E2 has a negative refractive power, an object-side surface S3 thereof is a convex surface, and an image-side surface S4 thereof is a concave surface. The third lens E3 has a negative refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a convex surface. The fifth lens E5 has a negative refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a concave surface. The seventh lens E7 has a negative refractive power, an object-side surface S13 thereof is a convex surface, and an image-side surface S14 thereof is a concave surface. The optical filter E8 has an object-side surface S15 and an image-side surface S16. Light from an object sequentially penetrates through each of the surfaces S1 to S16, and is finally imaged on the imaging surface S17.

In the embodiment, a total effective focal length f of the optical imaging lens assembly is 4.87 mm. TTL is a total length of the optical imaging lens assembly, and TTL is 6.55 mm. ImgH is a half of a diagonal length of an effective pixel region on the imaging surface of the optical imaging lens assembly, and ImgH is 4.18 mm. FNOₘᵢₙ is a minimum value of an F-number of the optical imaging lens assembly, and FNOₘᵢₙ is 1.40. FNOₘₐₓ is a maximum value of the F-number of the optical imaging lens assembly, and FNOₘₐₓ is 2.04. A relative aperture of the optical imaging lens assembly is the maximum when the F-number is the minimum value. The relative aperture of the optical imaging lens assembly is the minimum when the F-number is the maximum value.

Table 9 shows a basic parameter table of the optical imaging lens assembly of Embodiment 5, wherein the units of the curvature radius, the thickness/distance and the focal length are all millimeters (mm). Tables 10-1 and 10-2 show high-order coefficients that can be used for each aspheric mirror surface in Embodiment 5. A surface type of each aspheric surface may be defined by formula (1) given in Embodiment 1.

TABLE 9

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| S1 | Aspheric | 3.3157 | 0.8412 | 1.70 | 53.2 | 4.76 | −0.2579 |
| S2 | Spherical | 1.0000E+18 | 0.2158 | | | | |
| STO | Spherical | Infinite | −0.0658 | | | | |
| S3 | Aspheric | 5.4904 | 0.2550 | 1.68 | 19.2 | −8.91 | 8.2164 |
| S4 | Aspheric | 2.8221 | 0.4872 | | | | 0.3281 |
| S5 | Aspheric | 7.3947 | 0.2500 | 1.68 | 19.2 | −20.13 | −0.6908 |
| S6 | Aspheric | 4.7297 | 0.0933 | | | | −1.0000 |
| S7 | Aspheric | 8.7325 | 0.7161 | 1.57 | 37.3 | 13.27 | −1.0000 |
| S8 | Aspheric | −55.2004 | 0.5346 | | | | 0.0000 |
| S9 | Aspheric | 7.5840 | 0.4876 | 1.55 | 56.1 | −28.21 | 0.0000 |
| S10 | Aspheric | 4.9662 | 0.1573 | | | | −1.9560 |
| S11 | Aspheric | 1.9412 | 0.4548 | 1.55 | 56.1 | 5.00 | −1.0000 |
| S12 | Aspheric | 6.1548 | 0.6917 | | | | −1.0000 |
| S13 | Aspheric | 2.7489 | 0.4500 | 1.55 | 56.1 | −5.46 | −13.5874 |
| S14 | Aspheric | 1.3475 | 0.3995 | | | | −1.2191 |
| S15 | Spherical | Infinite | 0.1100 | 1.52 | 64.2 | | |
| 516 | Spherical | Infinite | 0.4718 | | | | |
| S17 | Spherical | Infinite | | | | | |

TABLE 10−1

| Surface | | | | | | | |
|---|---|---|---|---|---|---|---|
| number | A4 | A6 | A8 | A10 | A12 | A14 | A16 |
| S1 | −5.2584E−03 | 1.5277E−02 | −5.5690E−02 | 1.2990E−01 | −2.1189E−01 | 2.4317E−01 | −1.9747E−01 |
| S3 | −3.4953E−02 | 5.5129E−02 | −2.3299E−01 | 8.3764E−01 | −2.0053E+00 | 3.2930E+00 | −3.8169E+00 |
| S4 | −4.0229E−02 | −1.7291E−02 | 1.9760E−01 | −7.0666E−01 | 1.5590E+00 | −2.2855E+00 | 2.2806E+00 |
| S5 | −5.0838E−02 | 9.9055E−02 | −5.3292E−01 | 1.7083E+00 | −3.7227E+00 | 5.6530E+00 | −6.0859E+00 |
| S6 | −4.8466E−02 | 8.9562E−02 | −3.0756E−01 | 7.4751E−01 | −1.2838E+00 | 1.5592E+00 | −1.3456E+00 |
| S7 | −3.6207E−02 | 8.1581E−02 | −2.6866E−01 | 6.7019E−01 | −1.1304E+00 | 1.3008E+00 | −1.0362E+00 |
| S8 | −2.3962E−02 | −7.4170E−02 | 3.5580E−01 | −1.0557E+00 | 2.0970E+00 | −2.9050E+00 | 2.8737E+00 |
| S9 | −1.0639E−02 | −5.2876E−02 | 9.4846E−02 | −6.1965E−02 | −5.2998E−02 | 1.5373E−01 | −1.6373E−01 |
| S10 | −5.1425E−02 | −1.7744E−01 | 3.4875E−01 | −3.7812E−01 | 2.8548E−01 | −1.6049E−01 | 6.8886E−02 |
| S11 | 1.7726E−02 | −1.1360E−01 | 1.3197E−01 | −1.2008E−01 | 8.5479E−02 | −4.5862E−02 | 1.7969E−02 |
| S12 | 5.8903E−02 | 3.2306E−02 | −1.3870E−01 | 1.4710E−01 | −9.1019E−02 | 3.7437E−02 | −1.0768E−02 |
| S13 | −1.9457E−01 | 9.1590E−02 | −3.9515E−02 | 1.3569E−02 | −1.9917E−03 | −4.7049E−04 | 3.1229E−04 |
| S14 | −2.8951E−01 | 2.0454E−01 | −1.2697E−01 | 6.2663E−02 | −2.3342E−02 | 6.4565E−03 | −1.3211E−03 |

TABLE 10−2

| Surface | | | | | | | |
|---|---|---|---|---|---|---|---|
| number | A18 | A20 | A22 | A24 | A26 | A28 | A30 |
| S1 | 1.1352E−01 | −4.5784E−02 | 1.2648E−02 | −2.2764E−03 | 2.4027E−04 | −1.1274E−05 | 0.0000E+00 |
| S3 | 3.1714E+00 | −1.8956E+00 | 8.0785E−01 | −2.3941E−01 | 4.6868E−02 | −5.4472E−03 | 2.8458E−04 |
| S4 | −1.5548E+00 | 7.1251E−01 | −2.0981E−01 | 3.5849E−02 | −2.7000E−03 | 0.0000E+00 | 0.0000E+00 |
| S5 | 4.6765E+00 | −2.5491E+00 | 9.6315E−01 | −2.4000E−01 | 3.5491E−02 | −2.3605E−03 | 0.0000E+00 |
| S6 | 8.2662E−01 | −3.5844E−01 | 1.0706E−01 | −2.0938E−02 | 2.4121E−03 | −1.2417E−04 | 0.0000E+00 |
| S7 | 5.7410E−01 | −2.1937E−01 | 5.6279E−02 | −9.1665E−03 | 8.4514E−04 | −3.2933E−05 | 0.0000E+00 |
| S8 | −2.0536E+00 | 1.0613E+00 | −3.9247E−01 | 1.0115E−01 | −1.7243E−02 | 1.7459E−03 | −7.9451E−05 |
| S9 | 1.0638E−01 | −4.6369E−02 | 1.3880E−02 | −2.8232E−03 | 3.7326E−04 | −2.8940E−05 | 9.9817E−07 |
| S10 | −2.2773E−02 | 5.7830E−03 | −1.1081E−03 | 1.5431E−04 | −1.4635E−05 | 8.3951E−07 | −2.1849E−08 |
| S11 | −5.0849E−03 | 1.0347E−03 | −1.4976E−04 | 1.5028E−05 | −9.9281E−07 | 3.8800E−08 | −6.7910E−10 |
| S12 | 2.2166E−03 | −3.2862E−04 | 3.4783E−05 | −2.5613E−06 | 1.2444E−07 | −3.5781E−09 | 4.5996E−11 |
| S13 | −7.8546E−05 | 1.1966E−05 | −1.2038E−06 | 8.0841E−08 | −3.5019E−09 | 8.8758E−11 | −1.0019E−12 |
| S14 | 1.9954E−04 | −2.2118E−05 | 1.7737E−06 | −1.0003E−07 | 3.7607E−09 | −8.4573E−11 | 8.6037E−13 |

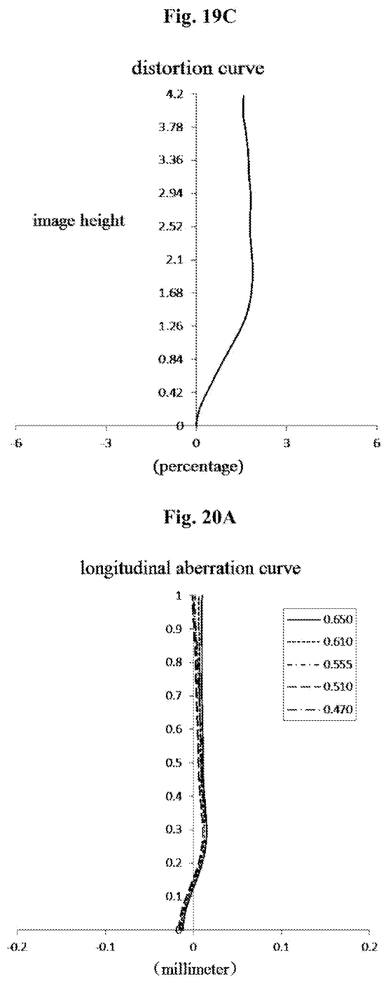

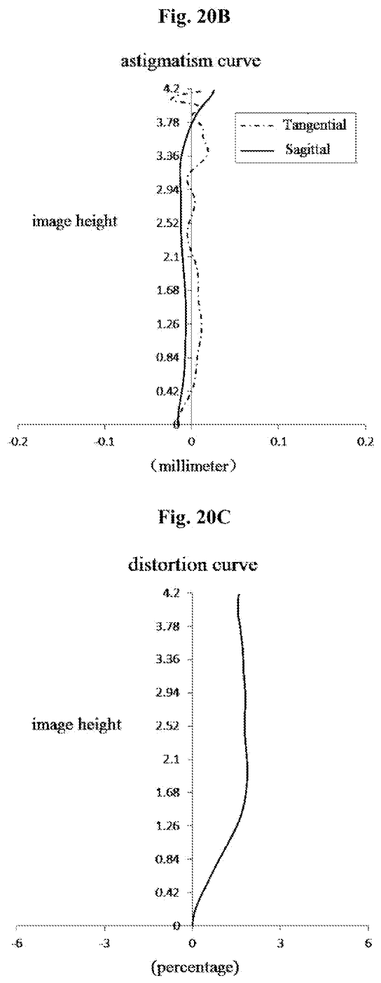

FIGS. 19A and 20A show longitudinal aberration curves of the optical imaging lens assembly with the F-numbers of 1.40 and 2.04 according to Embodiment 5 to represent deviations of a convergence focal point after light with different wavelengths passes through the lens respectively. FIGS. 19B and 20B show astigmatism curves of the optical imaging lens assembly with the F-numbers of 1.40 and 2.04 according to Embodiment 5 to represent a tangential image surface curvature and a sagittal image surface curvature respectively. FIGS. 19C and 20C show distortion curves of the optical imaging lens assembly with the F-numbers of 1.40 and 2.04 according to Embodiment 5 to represent distortion values corresponding to different image heights respectively. According to FIGS. 19A-20C, it can be seen that the optical imaging lens assembly provided in Embodiment 5 may achieve high imaging quality.

### Embodiment 6

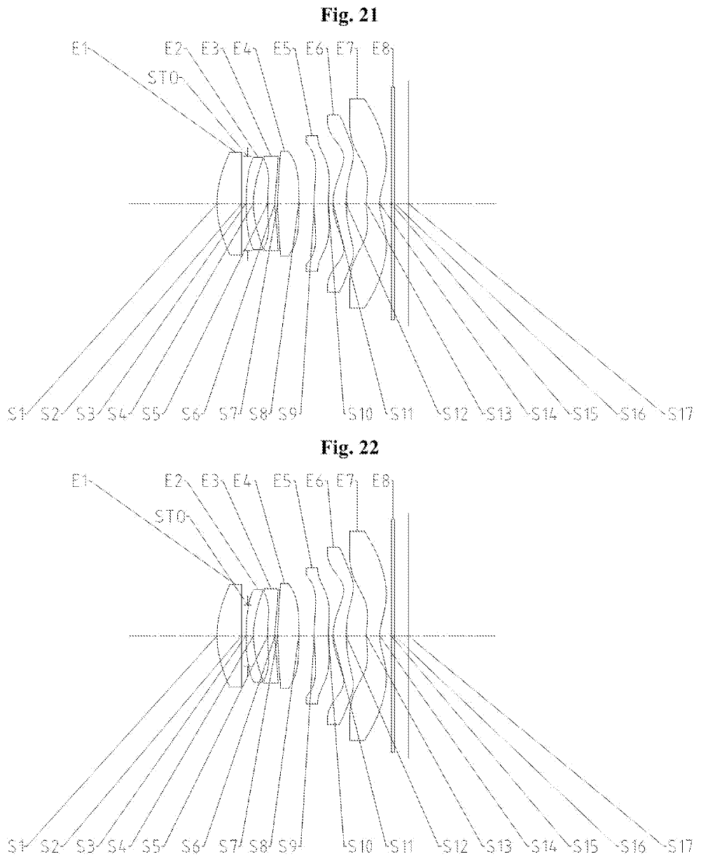

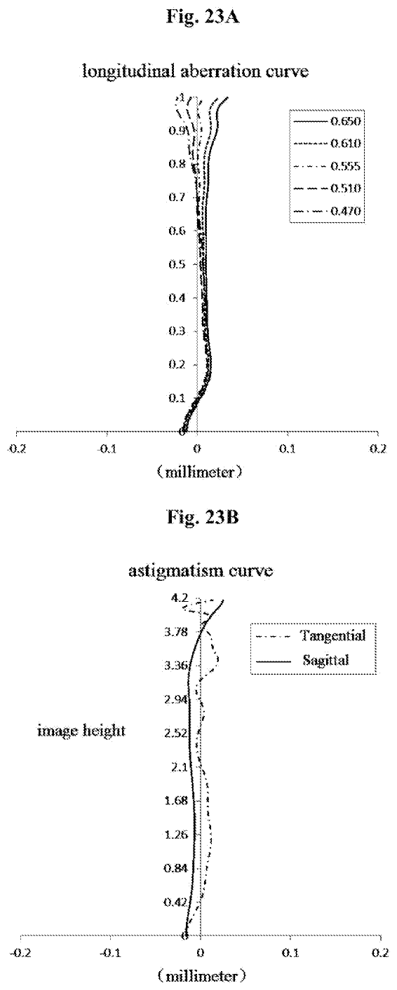

An optical imaging lens assembly according to Embodiment 6 of the disclosure will be described below with reference to FIGS. 21-24C. FIGS. 21 and 22 show structural schematic diagrams of an optical imaging lens assembly with F-numbers of 1.40 and 2.05 according to Embodiment 6 of the disclosure respectively.

As shown in FIGS. 21 and 22, the optical imaging lens assembly sequentially includes from an object side to an image side: a first lens E1, a variable diaphragm STO, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a flat surface. The second lens E2 has a negative refractive power, an object-side surface S3 thereof is a convex surface, and an image-side surface S4 thereof is a concave surface. The third lens E3 has a negative refractive power, an object-side surface S5 thereof is a convex surface, and an image-side surface S6 thereof is a concave surface. The fourth lens E4 has a positive refractive power, an object-side surface S7 thereof is a convex surface, and an image-side surface S8 thereof is a convex surface. The fifth lens E5 has a negative refractive power, an object-side surface S9 thereof is a convex surface, and an image-side surface S10 thereof is a concave surface. The sixth lens E6 has a positive refractive power, an object-side surface S11 thereof is a convex surface, and an image-side surface S12 thereof is a concave surface. The seventh lens E7 has a negative refractive power, an object-side surface S13 thereof is a convex surface, and an image-side surface S14 thereof is a concave surface. The optical filter E8 has an object-side surface S15 and an image-side surface S16. Light from an object sequentially penetrates through each of the surfaces S1 to S16, and is finally imaged on the imaging surface S17.

In the embodiment, a total effective focal length f of the optical imaging lens assembly is 4.87 mm. TTL is a total length of the optical imaging lens assembly, and TTL is 6.55 mm. ImgH is a half of a diagonal length of an effective pixel region on the imaging surface of the optical imaging lens assembly, and ImgH is 4.18 mm. FNOₘᵢₙ is a minimum value of an F-number of the optical imaging lens assembly, and FNOₘᵢₙ is 1.40. FNOₘₐₓ is a maximum value of the F-number of the optical imaging lens assembly, and FNOₘₐₓ is 2.05. A relative aperture of the optical imaging lens assembly is the maximum when the F-number is the minimum value. The relative aperture of the optical imaging lens assembly is the minimum when the F-number is the maximum value.

Table 11 shows a basic parameter table of the optical imaging lens assembly of Embodiment 6, wherein the units of the curvature radius, the thickness/distance and the focal length are all millimeters (mm). Tables 12-1 and 12-2 show high-order coefficients that can be used for each aspheric mirror surface in Embodiment 6. A surface type of each aspheric surface may be defined by formula (1) given in Embodiment 1.

TABLE 11

| | | | | Material | | | |
|---|---|---|---|---|---|---|---|
| Surface | Surface | Curvature | Thickness/ | Refractive | Abbe | Focal | Conic |
| number | type | radius | distance | index | number | length | coefficient |
| OBJ | Spherical | Infinite | Infinite | | | | |
| S1 | Aspheric | 3.3117 | 0.8414 | 1.70 | 53.2 | 4.76 | −0.2574 |
| S2 | Spherical | 1.0000E+18 | 0.2103 | | | | |
| STO | Spherical | Infinite | −0.0603 | | | | |
| S3 | Aspheric | 5.5065 | 0.2550 | 1.68 | 19.2 | −8.87 | 8.2205 |
| S4 | Aspheric | 2.8198 | 0.4898 | | | | 0.3240 |
| S5 | Aspheric | 7.3899 | 0.2500 | 1.68 | 19.2 | −19.99 | 1.1194 |
| S6 | Aspheric | 4.7163 | 0.0927 | | | | −1.0000 |
| S7 | Aspheric | 8.5365 | 0.7200 | 1.57 | 37.3 | 13.21 | −1.0000 |
| S8 | Aspheric | −62.3237 | 0.5305 | | | | 0.0000 |
| S9 | Aspheric | 7.6382 | 0.4851 | 1.55 | 56.1 | −28.73 | 0.0000 |
| S10 | Aspheric | 5.0213 | 0.1579 | | | | −2.5276 |
| S11 | Aspheric | 1.9399 | 0.4543 | 1.55 | 56.1 | 5.00 | −1.0000 |
| S12 | Aspheric | 6.1521 | 0.6924 | | | | −1.0000 |
| S13 | Aspheric | 2.7849 | 0.4500 | 1.55 | 56.1 | −5.45 | −13.9704 |
| S14 | Aspheric | 1.3558 | 0.3993 | | | | −1.2197 |
| S15 | Spherical | Infinite | 0.1100 | 1.52 | 64.2 | | |
| S16 | Spherical | Infinite | 0.4716 | | | | |
| S17 | Spherical | Infinite | | | | | |

TABLE 12-1

| Surface number | A4 | A6 | A8 | A10 | A12 | A14 | A16 |
|---|---|---|---|---|---|---|---|
| S1 | −5.3231E−03 | 1.5724E−02 | −5.7023E−02 | 1.3213E−01 | −2.1396E−01 | 2.4395E−01 | −1.9705E−01 |
| S3 | −3.5093E−02 | 5.6083E−02 | −2.3531E−01 | 8.3825E−01 | −1.9922E+00 | 3.2507E+00 | −3.7459E+00 |
| S4 | −4.0345E−02 | −1.5066E−02 | 1.8715E−01 | −6.7376E−01 | 1.4873E+00 | −2.1772E+00 | 2.1671E+00 |
| S5 | −5.1695E−02 | 1.0392E−01 | −5.5395E−01 | 1.7735E+00 | −3.8626E+00 | 5.8600E+00 | −6.2992E+00 |
| S6 | −4.9370E−02 | 8.9630E−02 | −2.9760E−01 | 7.0878E−01 | −1.2010E+00 | 1.4427E+00 | −1.2323E+00 |
| S7 | −3.7485E−02 | 8.2081E−02 | −2.6628E−01 | 6.6171E−01 | −1.1155E+00 | 1.2850E+00 | −1.0258E+00 |
| S8 | −2.4465E−02 | −6.9853E−02 | 3.3221E−01 | −9.7693E−01 | 1.9228E+00 | −2.6412E+00 | 2.5932E+00 |
| S9 | −1.0511E−02 | −5.1694E−02 | 9.3186E−02 | −6.0880E−02 | −5.2502E−02 | 1.5155E−01 | −1.6103E−01 |
| S10 | −5.2919E−02 | −1.7304E−01 | 3.4461E−01 | −3.7475E−01 | 2.8284E−01 | −1.5877E−01 | 6.8023E−02 |
| S11 | 1.6711E−02 | −1.1438E−01 | 1.3467E−01 | −1.2384E−01 | 8.9122E−02 | −4.8298E−02 | 1.9089E−02 |
| S12 | 6.0840E−02 | 2.8092E−02 | −1.3572E−01 | 1.4651E−01 | −9.1411E−02 | 3.7769E−02 | −1.0893E−02 |
| S13 | −1.9126E−01 | 8.8992E−02 | −3.8434E−02 | 1.3237E−02 | −1.9419E−03 | −4.5573E−04 | 3.0158E−04 |
| S14 | −2.8589E−01 | 2.0132E−01 | −1.2514E−01 | 6.1944E−02 | −2.3152E−02 | 6.4228E−03 | −1.3168E−03 |

TABLE 12-2

| Surface number | A18 | A20 | A22 | A24 | A26 | A28 | A30 |
|---|---|---|---|---|---|---|---|
| S1 | 1.1282E−01 | −4.5360E−02 | 1.2502E−02 | −2.2464E−03 | 2.3680E−04 | −1.1102E−05 | 0.0000E+00 |
| S3 | 3.0955E+00 | −1.8409E+00 | 7.8083E−01 | −2.3039E−01 | 4.4922E−02 | −5.2019E−03 | 2.7088E−04 |
| S4 | −1.4729E+00 | 6.7266E−01 | −1.9736E−01 | 3.3593E−02 | −2.5200E−03 | 0.0000E+00 | 0.0000E+00 |
| S5 | 4.8293E+00 | −2.6241E+00 | 9.8750E−01 | −2.4487E−01 | 3.6006E−02 | −2.3794E−03 | 0.0000E+00 |
| S6 | 7.4909E−01 | −3.2112E−01 | 9.4681E−02 | −1.8242E−02 | 2.0654E−03 | −1.0421E−04 | 0.0000E+00 |
| S7 | 5.7027E−01 | −2.1900E−01 | 5.6600E−02 | −9.3212E−03 | 8.7426E−04 | −3.5035E−05 | 0.0000E+00 |
| S8 | −1.8410E+00 | 9.4590E−01 | −3.4795E−01 | 8.9244E−02 | −1.5143E−02 | 1.5265E−03 | −6.9164E−05 |
| S9 | 1.0440E−01 | −4.5411E−02 | 1.3565E−02 | −2.7534E−03 | 3.6328E−04 | −2.8108E−05 | 9.6747E−07 |
| S10 | −2.2447E−02 | 5.6902E−03 | −1.0885E−03 | 1.5134E−04 | −1.4331E−05 | 8.2082E−07 | −2.1330E−08 |
| S11 | −5.4455E−03 | 1.1166E−03 | −1.6286E−04 | 1.6468E−05 | −1.0962E−06 | 4.3169E−08 | −7.6135E−10 |
| S12 | 2.2467E−03 | −3.3361E−04 | 3.5365E−05 | −2.6079E−06 | 1.2689E−07 | −3.6537E−09 | 4.7033E−11 |
| S13 | −7.5536E−05 | 1.1458E−05 | −1.1477E−06 | 7.6740E−08 | −3.3098E−09 | 8.3527E−11 | −9.3877E−13 |
| S14 | 1.9909E−04 | −2.2071E−05 | 1.7692E−06 | −9.9700E−08 | 3.7450E−09 | −8.4159E−11 | 8.5579E−13 |

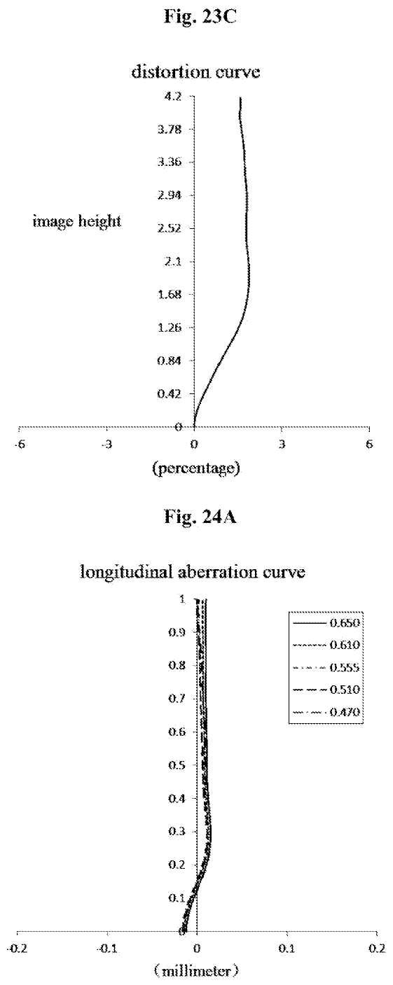

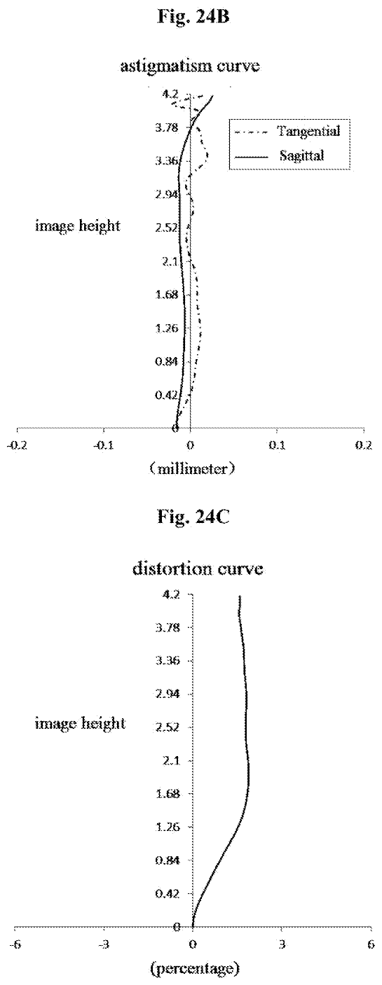

FIGS. 23A and 24A show longitudinal aberration curves of the optical imaging lens assembly with the F-numbers of 1.40 and 2.05 according to Embodiment 6 to represent deviations of a convergence focal point after light with different wavelengths passes through the lens respectively. FIGS. 23B and 24B show astigmatism curves of the optical imaging lens assembly with the F-numbers of 1.40 and 2.05 according to Embodiment 6 to represent a tangential image surface curvature and a sagittal image surface curvature respectively. FIGS. 23C and 24C show distortion curves of the optical imaging lens assembly with the F-numbers of 1.40 and 2.05 according to Embodiment 6 to represent distortion values corresponding to different image heights respectively. According to FIGS. 23A-24C, it can be seen that the optical imaging lens assembly provided in Embodiment 6 may achieve high imaging quality.

From the above, Embodiment 1 to Embodiment 6 satisfy a relationship shown in Table 13 respectively.

TABLE 13

| | Embodiment | | | | | |
|---|---|---|---|---|---|---|
| Conditional expression | 1 | 2 | 3 | 4 | 5 | 6 |
| f1/(EPDmax − EPDmin) | 4.21 | 4.21 | 4.22 | 4.22 | 4.31 | 4.30 |
| f3/(f2 + f7) | 1.59 | 1.54 | 1.48 | 1.55 | 1.40 | 1.40 |
| f4/R7 | 1.45 | 1.46 | 1.34 | 1.36 | 1.52 | 1.55 |
| (R11 + R12)/f6 | 1.63 | 1.63 | 1.48 | 1.27 | 1.62 | 1.62 |
| R3/R4 | 2.00 | 2.00 | 2.08 | 2.13 | 1.95 | 1.95 |
| R5/R6 | 1.57 | 1.57 | 1.60 | 1.59 | 1.56 | 1.57 |
| (CT1 + T12)/(CT2 + T23 + CT3) | 1.00 | 0.99 | 0.99 | 1.00 | 1.00 | 1.00 |
| (DT31 + DT32)/DT11 | 1.72 | 1.72 | 1.73 | 1.72 | 1.76 | 1.77 |
| f34/f12 | 2.92 | 3.05 | 3.07 | 3.10 | 4.78 | 4.78 |
| f56/(CT5 + CT6) | 7.06 | 6.97 | 6.90 | 7.05 | 6.63 | 6.61 |
| (SAG71 + SAG72)/ | 1.20 | 1.20 | 1.43 | 1.55 | 1.67 | 1.70 |
| (SAG51 + SAG52) | | | | | | |

The disclosure also provides an imaging device, of which an electronic photosensitive element may be a Charge-Coupled Device (CCD) or a Complementary Metal Oxide Semiconductor (CMOS). The imaging device may be an independent imaging device such as a digital camera, or may be an imaging module integrated into a mobile electronic device such as a mobile phone. The imaging device is provided with the above-mentioned optical imaging lens assembly.

The above description is only description about the preferred embodiments of the disclosure and adopted technical principles. It is understood by those skilled in the art that the scope of invention involved in the disclosure is not limited to the technical solutions formed by specifically combining the technical characteristics and should also cover other technical solutions formed by freely combining the technical characteristics or equivalent characteristics thereof without departing from the inventive concept, for example, technical solutions formed by mutually replacing the characteristics and (but not limited to) the technical characteristics with similar functions disclosed in the disclosure.

What is claimed is:

1. An optical imaging lens assembly, sequentially comprising from an object side to an image side along an optical axis:
a first lens with a positive refractive power, an object-side surface thereof is a convex surface, and an image-side surface thereof is a flat surface;
a variable diaphragm;
a second lens with a negative refractive power;
a third lens with a refractive power;
a fourth lens with a positive refractive power, an image-side surface thereof is a convex surface;
a fifth lens with a refractive power;
a sixth lens with a positive refractive power; and
a seventh lens with a negative refractive power; wherein
the first lens is a glass lens, and the image-side surface of the first lens is a spherical mirror surface.

2. The optical imaging lens assembly according to claim 1, wherein an effective focal length f2 of the second lens, an effective focal length f3 of the third lens and an effective focal length f7 of the seventh lens satisfy 1.0<f3/(f2+f7)<2.0.

3. The optical imaging lens assembly according to claim 1, wherein an effective focal length f4 of the fourth lens and a curvature radius R7 of an object-side surface of the fourth lens satisfy 1.2<f4/R7<1.7.

4. The optical imaging lens assembly according to claim 1, wherein a curvature radius R12 of an image-side surface of the sixth lens, a curvature radius R11 of an object-side surface of the sixth lens and an effective focal length f6 of the sixth lens satisfy 1.2<(R11+R12)/f6<1.7.

5. The optical imaging lens assembly according to claim 1, wherein a curvature radius R3 of an object-side surface of the second lens and a curvature radius R4 of an image-side surface of the second lens satisfy 1.8<R3/R4<2.3.

6. The optical imaging lens assembly according to claim 1, wherein a curvature radius R5 of an object-side surface of the third lens and a curvature radius R6 of an image-side surface of the third lens satisfy 1.4<R5/R6<2.0.

7. The optical imaging lens assembly according to claim 1, wherein a center thickness CT1 of the first lens on the optical axis, a center thickness CT2 of the second lens on the optical axis, a center thickness CT3 of the third lens on the optical axis, a spacing distance T12 of the first lens and the second lens on the optical axis and a spacing distance T23 of the second lens and the third lens on the optical axis satisfy 0.8<(CT1+T12)/(CT2+T23+CT3)<1.2.

8. The optical imaging lens assembly according to claim 1, wherein an effective radius DT31 of an object-side surface of the third lens, an effective radius DT32 of an image-side surface of the third lens and an effective radius DT11 of the object-side surface of the first lens satisfy 1.6<(DT31+DT32)/DT11<2.0.

9. The optical imaging lens assembly according to claim 1, wherein a combined focal length f12 of the first lens and the second lens and a combined focal length f34 of the third lens and the fourth lens satisfy 2.9<f34/f12<4.9.

10. The optical imaging lens assembly according to claim 1, wherein a combined focal length f56 of the fifth lens and the sixth lens, a center thickness CT5 of the fifth lens on the optical axis and a center thickness CT6 of the sixth lens on the optical axis satisfy 6.5<f56/(CT5+CT6)<7.5.

11. The optical imaging lens assembly according to claim 1, wherein SAG52 is a distance from an intersection point of an image-side surface of the fifth lens and the optical axis to an effective radius vertex of the image-side surface of the fifth lens on the optical axis, SAG51 is a distance from an intersection point of an object-side surface of the fifth lens and the optical axis to an effective radius vertex of the object-side surface of the fifth lens on the optical axis, SAG72 is a distance from an intersection point of an image-side surface of the seventh lens and the optical axis to an effective radius vertex of the image-side surface of the seventh lens on the optical axis, SAG71 is a distance from an intersection point of an object-side surface of the seventh lens and the optical axis to an effective radius vertex of the object-side surface of the seventh lens on the optical axis, and SAG52, SAG51, SAG72 and SAG71 satisfy 1.1<(SAG71+SAG72)/(SAG51+SAG52)<1.8.

12. The optical imaging lens assembly according to claim 1, wherein EPDₘₐₓ is a maximum entrance pupil diameter of the optical imaging lens assembly, EPDₘᵢₙ is a minimum entrance pupil diameter of the optical imaging lens assembly, and EPDₘₐₓ, EPDₘᵢₙ and an effective focal length f1 of the first lens satisfy 4.0≤f1/(EPDₘₐₓ−EPDₘᵢₙ)<5.0.

13. The optical imaging lens assembly according to claim 1, wherein an object-side surface of the fifth lens is a convex surface, and an image-side surface of the fifth lens is a concave surface.

14. The optical imaging lens assembly according to claim 1, wherein an object-side surface of the sixth lens is a convex surface, and an image-side surface of the sixth lens is a concave surface.

15. An optical imaging lens assembly, sequentially comprising from an object side to an image side along an optical axis:
a first lens with a positive refractive power, an object-side surface thereof is a convex surface, and an image-side surface thereof is a flat surface;
a variable diaphragm;
a second lens with a negative refractive power;
a third lens with a refractive power;
a fourth lens with a positive refractive power, an image-side surface thereof is a convex surface;
a fifth lens with a refractive power;
a sixth lens with a positive refractive power; and
a seventh lens with a negative refractive power, wherein
EPDₘₐₓ is a maximum entrance pupil diameter of the optical imaging lens assembly, EPDₘᵢₙ is a minimum entrance pupil diameter of the optical imaging lens assembly, and EPDₘₐₓ, EPDₘᵢₙ and an effective focal length f1 of the first lens satisfy 4.0<f1/(EPDₘₐₓ−EPDₘᵢₙ)<5.0.

16. The optical imaging lens assembly according to claim 15, wherein an effective focal length f2 of the second lens, an effective focal length f3 of the third lens and an effective focal length f7 of the seventh lens satisfy 1.0<f3/(f2+f7)<2.0.

17. The optical imaging lens assembly according to claim 15, wherein an effective focal length f4 of the fourth lens and a curvature radius R7 of an object-side surface of the fourth lens satisfy 1.2<f4/R7<1.7.

18. The optical imaging lens assembly according to claim 15, wherein a curvature radius R12 of an image-side surface of the sixth lens, a curvature radius R11 of an object-side surface of the sixth lens and an effective focal length f6 of the sixth lens satisfy 1.2<(R11+R12)/f6<1.7.

19. The optical imaging lens assembly according to claim 15, wherein a curvature radius R3 of an object-side surface of the second lens and a curvature radius R4 of an image-side surface of the second lens satisfy 1.8<R3/R4<2.3.

20. The optical imaging lens assembly according to claim 15, wherein a curvature radius R5 of an object-side surface of the third lens and a curvature radius R6 of an image-side surface of the third lens satisfy 1.4<R5/R6<2.0.
